(19) United States
(12) Patent Application Publication
(10) Pub. No.: US 2024/0060155 A1
(43) Pub. Date: Feb. 22, 2024

(54) MULTI-ELEMENT COMPOUND NANOPARTICLES, AND SYSTEMS AND METHODS OF MAKING AND USE THEREOF

(71) Applicant: UNIVERSITY OF MARYLAND, COLLEGE PARK, College Park, MD (US)

(72) Inventors: Liangbing HU, Rockville, MD (US); Yonggang YAO, College Park, MD (US); Tangyuan LI, College Park, MD (US); Mingjin CUI, College Park, MD (US); Jinlong GAO, College Park, MD (US)

(21) Appl. No.: 18/267,501

(22) PCT Filed: Dec. 15, 2021
(86) PCT No.: PCT/US21/63487

§ 371 Date: Jun. 15, 2023

Related U.S. Application Data
(60) Provisional application No. 63/125,918, filed on Dec. 15, 2020.

(51) Int. Cl. C22C 1/047; B22F 1/054; B22F 9/20

(52) U.S. Cl. CPC C22C 1/047; B22F 1/054; B22F 9/20; B22F 2301/40; B22F 2998/10

(57) ABSTRACT

A structure can comprise one or multi-element compound (MEC) nanoparticles. Each MEC nanoparticle can have a plurality of sites comprising one or more elements. Each site can form a compound bond with at least one other site of the MEC nanoparticle. One or more of the compound bonds can comprise a covalent bond, an ionic bond, or a metallic bond. Each MEC nanoparticle can be formed of at least three different elements. For example, one or more MEC nanoparticles can be a multi-element oxide nanoparticle, a multi-element carbide nanoparticle, a multi-element intermetallic nanoparticle, or any other type of compound nanoparticle.

### CROSS-REFERENCE TO RELATED APPLICATION

The present application claims the benefit of U.S. Provisional Application No. 63/125,918, filed Dec. 15, 2020, entitled “Multi-elemental Compound Nanoparticles and Methods of Making the Same,” which is incorporated by reference herein in its entirety.

### FIELD

The present disclosure relates generally to engineered multi-element particles, and more particularly, to multi-element compound nanoparticles, and methods of making and using such nanoparticles.

### BACKGROUND

Multi-element compound (MEC) nanoparticles can provide synergistic interaction between different elements that often outperforms their unary counterparts. However, synthesizing MEC nanoparticles remains a significant challenge, due in part to the difficulty of mixing multiple dissimilar elements at the nanoscale. Conventional wet-chemistry approaches (e.g., hydrothermal and co-precipitation) performed at relatively low temperatures (e.g., 300-673 K) may lack the activation energy to overcome the kinetic barriers for mixing multiple elements and to drive the compound formation. As a result, conventional approaches tend to yield a final product with phase separation. High-temperature thermal treatment (e.g., >700 K) offers higher activation energy and faster kinetics, thereby promoting multi-element mixing into a single phase. However, conventional high-temperature strategies (e.g., sintering) are energy-intensive and difficult to control for nanomaterial synthesis. For example, conventional approaches may require significant time to heat to the desired high temperature, leading to relatively long reaction times (e.g., on the order of minutes), which can lead to extensive overgrowth and agglomeration of particles.

Embodiments of the disclosed subject matter may address one or more of the above-noted problems and disadvantages, among other things.

### SUMMARY

Embodiments of the disclosed subject matter system provide multi-element compound (MEC) nanoparticles, and systems and methods of making and use thereof. The high temperature fabrication strategies disclosed herein can be employed, alone or in combination, to drive decomposition of precursors on a substrate, and subsequent mixing of the multiple elements (e.g., 3 or more different elements, such as 5-10 different elements) and formation of compounds of diverse compositions, such as but not limited to multi-element oxide (MEO) nanoparticles, multi-element carbide (ME-carbide) nanoparticles, and multi-element intermetallic (MEI) nanoparticles. The heating can be precisely controlled to achieve desired composition, structure, and/or other properties. For example, in some embodiments, the exposure to high temperatures can be sufficiently short to avoid structural deterioration and/or particle aggregation. In some embodiments, additional heating at a same or different temperature (e.g., higher) and/or longer duration (e.g., 1-10 minutes) can be subsequently administered, for example, to convert an MEO nanoparticle into an ME-carbide nanoparticle or to convert a disordered multi-metal particle into an MEI nanoparticle.

In one or more embodiments, a structure can comprise one or more MEC nanoparticles. Each MEC nanoparticle can have a plurality of sites comprising one or more elements. Each site can form a compound bond with at least one other site of the compound nanoparticle. One or more of the compound bonds can comprise a covalent bond, an ionic bond, and/or a metallic bond. Each MEC nanoparticle can be formed of at least three different elements.

In one or more embodiments, a method can comprise providing a substrate with a plurality of metal salt precursors thereon. At least one of the metal salt precursors can comprise oxygen (O), and the plurality of metal salt precursors can comprise at least three different metal elements. The method can further comprise heating the substrate from an initial temperature to a first temperature at a first heating rate of at least 10⁴ K/s, and maintaining the substrate at the first temperature for a first time period. The method can also comprise, at an end of the first time period, cooling the substrate from the first temperature to a second temperature at a first cooling rate of at least 10⁵ K/s. The initial temperature and the second temperature can be less than 500 K. The heating, the maintaining, and the cooling can be such that the metal salt precursors on the substrate are converted to one or more MEO nanoparticles. Each MEO nanoparticle can comprise O and the at least three metal elements in a single homogenous phase.

In some embodiments, the method can further comprise providing a coating on and at least partially enclosing the one or more MEO nanoparticles. The method can also comprise heating the substrate from a third temperature to a fourth temperature at a second heating rate slower than the first heating rate. The method can further comprise maintaining the substrate at the fourth temperature for a second time period, and, at an end of the second time period, cooling the substrate from the fourth temperature to a fifth temperature at a second cooling rate of at least 10⁵ K/s. The third temperature and the fifth temperature can be less than 500K. The heating to the fourth temperature, the maintaining at the fourth temperature, and the cooling from the fourth temperature can be such that the one or more MEO nanoparticles and the coating are converted to one or more ME-carbide nanoparticles. Each multi-element carbide nanoparticle can comprise carbon (C) and the at least three metal elements in a single homogenous phase.

In one or more embodiments, another method can comprise providing a substrate with one or more high entropy alloy (HEA) nanoparticles thereon. Each HEA nanoparticle can comprise at least three different metal elements. The method can further comprise heating the substrate to a first temperature at a first heating rate of at least 10⁴ K/s, and maintaining the substrate at the first temperature for a first time period. The method can also comprise, at an end of the first time period, cooling the substrate from the first temperature to a second temperature at a first cooling rate of at least 10⁵ K/s. The second temperature can be less than 500 K, the first temperature can be greater than 1000 K, and the first time period can be in a range of 1 minute to 10 minutes, inclusive. The heating, the maintaining, and the cooling can be such that the one or more HEA nanoparticles are converted to one or more multi-element intermetallic (MEI) nanoparticles. Each MEI nanoparticle can comprise the at least five metal elements in a single phase.

In some embodiments, the providing the substrate with one or more HEA nanoparticles thereon can comprise providing the substrate with a plurality of metal salt precursors thereon, heating the substrate from an initial temperature to a third temperature at a second heating rate of at least 10⁴ K/s, maintaining the substrate at the third temperature for a second time period, and, at an end of the second time period, cooling the substrate from the third temperature to a fourth temperature at a second cooling rate of at least 10⁵ K/s. The plurality of metal salt precursors can comprise the at least five different metal elements. The initial temperature and the fourth temperature can be less than 500 K, the third temperature can be greater than 1000 K, and the second time period can be in a range of 10 ms to 100 ms, inclusive. The heating to the third temperature, the maintaining at the third temperature, and the cooling from the third temperature can be such that the metal salt precursors on the substrate are converted to the one or more HEA nanoparticles.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a simplified schematic diagram illustrating aspects of a conventional multi-element nanoparticle having multiple phases.

FIG. 1B is a simplified schematic diagram illustrating aspects of a multi-element oxide (MEO) nanoparticle having a single homogenous phase, according to one or more embodiments of the disclosed subject matter.

FIG. 1C is a simplified schematic diagram of a carbon-nanofiber (CNF) substrate with MEO nanoparticles, according to one or more embodiments of the disclosed subject matter.

FIGS. 1D-1E are scanning electron microscope (SEM) images showing overview and magnified views of a CNF substrate with fabricated MEO nanoparticles, according to one or more embodiments of the disclosed subject matter.

FIG. 2A is a simplified schematic diagram illustrating aspects of a multi-element high-entropy alloy (HEA) forming a disordered solid solution phase.

FIG. 2B is a simplified schematic diagram illustrating aspects of a multi-element intermetallic (MEI) nanoparticle having an ordered solid solution phase, according to one or more embodiments of the disclosed subject matter.

FIG. 2C shows an exemplary lattice structure of an octonary MEI nanoparticle, according to one or more embodiments of the disclosed subject matter.

FIGS. 2D-2F show high-angle annular dark-field imaging (HAADF) scanning transmission electron microscope (STEM) images of a fabricated octonary (Pt_{0.8}Pd_{0.1}Au_{0.1})(Fe_{0.6}Co_{0.1}Ni_{0.1}Cu_{0.1}Sn_{0.1}) MEI nanoparticle, according to one or more embodiments of the disclosed subject matter.

FIG. 2G is a simplified schematic diagram of a CNF substrate with MEI nanoparticles, according to one or more embodiments of the disclosed subject matter.

FIG. 3A is a process flow diagram of an exemplary method for forming an MEO nanoparticle, according to one or more embodiments of the disclosed subject matter.

FIG. 3B is a graph depicting aspects of an exemplary pulse heating profile that can be employed to form an MEO nanoparticle, according to one or more embodiments of the disclosed subject matter.

FIG. 3C is a schematic diagram illustrating exemplary synthesis strategies for forming a single-phase MEO nanoparticle, according to one or more embodiments of the disclosed subject matter.

FIG. 3D is a graph of the formation Gibbs free energies of different oxides as a function of temperature illustrating the oxidation potential of different elements.

FIG. 3E shows X-ray diffraction (XRD) patterns of (Zr,Ce,Hf,Ti)Oₓ nanoparticles synthesized at 1000 K (illustrating phase separation), (Zr,Ce,Hf,Ti)O₂ nanoparticles synthesized at 1550 K, and (Ca,Mg)(Ti,Nb,Mn)O₃₋ₓ nanoparticles synthesized at 1150K on a CNF substrate, according to one or more embodiments of the disclosed subject matter.

FIG. 3F shows XRD patterns of (Fe,Co,Ni,Cu) nanoparticles fabricated by low P_{O2} (˜1 ppm) synthesis, (Fe,Co,Ni,Cu)Oₓ nanoparticles fabricated by high P_{O2} (air) synthesis, and (Mn,Fe,Co,Ni)₃O₄₋ₓ nanoparticles fabricated by high P_{O2} (air) synthesis, according to one or more embodiments of the disclosed subject matter.

FIG. 3G shows XRD patterns of (Zr,Ce,Hf)_{0.9}Pd_{0.1}Oₓ nanoparticles (illustrating phase separation) and (Zr,Ce,Hf,Ti,La,Y,Gd,Sm,Dy,Pd)O₂₋ₓ nanoparticles (illustrating single phase), according to one or more embodiments of the disclosed subject matter.

FIG. 4A is a process flow diagram of an exemplary method for forming a multi-element carbide (ME-carbide) nanoparticle, according to one or more embodiments of the disclosed subject matter.

FIG. 4B is a schematic diagram illustrating exemplary synthesis of a single-phase ME-carbide nanoparticle, according to one or more embodiments of the disclosed subject matter.

FIG. 4C is a graph depicting aspects of an exemplary heating profile for carbonization that can be employed to form an ME-carbide nanoparticle, according to one or more embodiments of the disclosed subject matter.

FIG. 4D is a graph depicting aspects of another exemplary heating profile for carbonization that can be employed to form an ME-carbide nanoparticle, according to one or more embodiments of the disclosed subject matter.

FIG. 5A is a process flow diagram of an exemplary method for forming a multi-element intermetallic (MEI) nanoparticle, according to one or more embodiments of the disclosed subject matter.

FIG. 5B is a graph depicting aspects of an exemplary heating profile for forming an MEI nanoparticle, according to one or more embodiments of the disclosed subject matter.

FIG. 5C shows XRD patterns of a quinary Pt(Fe_{0.7}Co_{0.1}Ni_{0.1}Cu_{0.1}) MEI nanoparticles resulting from different anneal times at ˜ 1100 K, according to one or more embodiments of the disclosed subject matter.

FIG. 5D is a graph of long-range order (LRO) as a function of quinary MEI nanoparticle size, according to one or more embodiments of the disclosed subject matter.

FIG. 6 depicts a generalized example of a computing environment in which the disclosed technologies may be implemented.

FIG. 7A is a graph of methane conversion versus reaction temperature in an experimental setup using (Zr,Ce)_{0.6}(Mg,La,Y,Hf,Ti,Cr,Mn)_{0.3}Pd_{0.1}O₂₋ₓ nanoparticles (10-MEO-PdO) and a control sample of (Zr,Ce)_{0.6}(Mg,Hf,Ti,Cr,Mn,Fe,Cu)_{0.3}Pd_{0.1}Oₓ nanoparticles (10-MEO-FeCu) as catalysts.

FIG. 7B is a graph of methane conversion versus reaction temperature in an experimental setup using PdOₓ, 9-MEO ((Zr,Ce)_{0.66}(Mg,La,Y,Hf,Ti,Cr,Mn)_{0.34}O₂₋ₓ) without Pd, and 10-MEO-PdO as catalysts.

FIG. 7C is a graph of methane conversion versus time in an experimental setup using PdOₓ, 4-MEO-Pd ((Zr,Ce)_{0.6}Mg_{0.3}Pd_{0.1}Oₓ), and 10-MEO-PdO as catalysts.

FIG. 7D shows XRD patterns of denary element particles having different Pd content fabricated using the disclosed synthesis techniques.

FIG. 7E shows an XRD pattern of a denary element particle having 10 at % Pd synthesized by annealing in an Ar atmosphere at 1273K for 2 hours.

FIG. 8A is a graph comparing hydrogen evolution reaction (HER) performance of various oxide and carbide nanoparticles using linear sweep voltammetry at a scan rate of 5 mV/s.

FIG. 8B is a graph comparing HER performance of MoG₂ and (TiZrVNbMo)Cₓ nanoparticles using chronoamperometry at 10 mA/cm².

FIG. 9A is a graph of LRO of quinary Pt(Fe_{0.7}Co_{0.1}Ni_{0.1}Cu_{0.1}) nanoparticles as a function of order heating time.

FIG. 9B shows XRD patterns of quinary Pt(Fe_{0.7}Co_{0.1}Ni_{0.1}Cu_{0.1}) nanoparticles at different order heating times.

FIGS. 9C-9E are STEM images of quinary Pt(Fe_{0.7}Co_{0.1}Ni_{0.1}Cu_{0.1}) nanoparticles at order heating times of 0.5 s, 1 minute, and 5 minutes, respectively.

FIG. 9F is a simplified schematic diagram of an ethanol fuel cell test setup employing an octonary (Pt_{0.8}Pd_{0.1}Au_{0.1})(Fe_{0.6}Co_{0.1}Ni_{0.1}Cu_{0.1}Sn_{0.1}) intermetallic nanoparticle as an anode catalyst.

FIG. 9G is a graph of ethanol electrooxidation reaction (EOR) performance of octonary (Pt_{0.8}Pd_{0.1}Au_{0.1})(Fe_{0.6}Co_{0.1}Ni_{0.1}Cu_{0.1}Sn_{0.1}) intermetallic nanoparticle, binary PtFe nanoparticles, and commercial Pt/C catalyst in 1 M KOH and 1 M EtOH using cyclic voltammetry (CV).

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of skill in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of skill in the art to have a more definitive construction, the numerical parameters set forth are approximations that may depend on the desired properties sought and/or limits of detection under standard test conditions/methods, as known to those of skill in the art. When directly and explicitly distinguishing embodiments from discussed prior art, the embodiment numbers are not approximates unless the word “about” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein, but are not intended to be limiting. For example, certain terms may be used such as “inner,” “outer,”, “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part and the object remains the same.

As used herein, “comprising” means “including,” and the singular forms “a” or “an” or “the” include plural references unless the context clearly dictates otherwise. The term “or” refers to a single element of stated alternative elements or a combination of two or more elements, unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one of skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following explanations of specific terms and abbreviations are provided to facilitate the description of various aspects of the disclosed subject matter and to guide those of skill in the art in the practice of the disclosed subject matter.

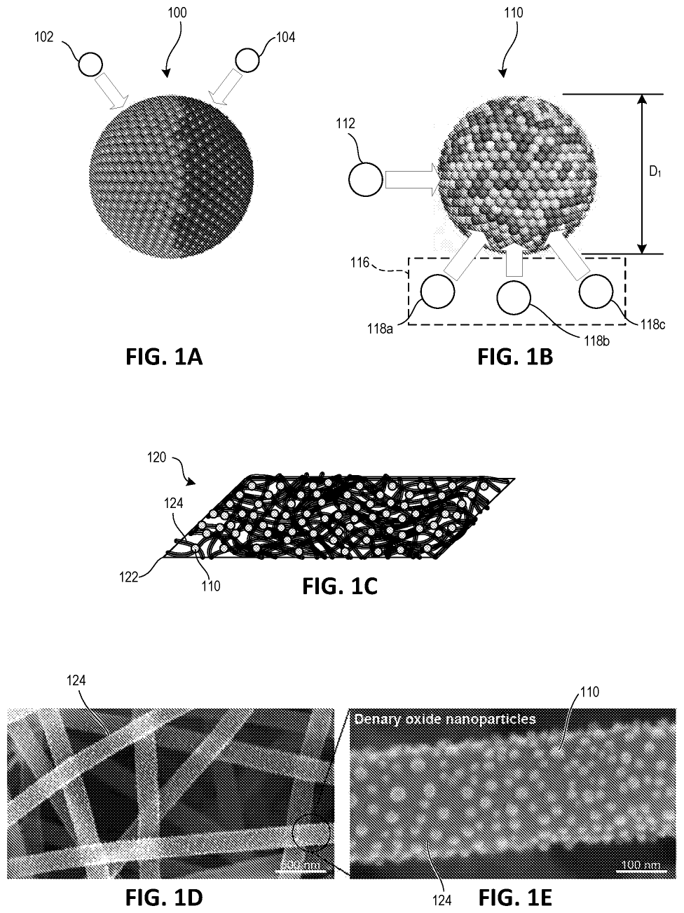

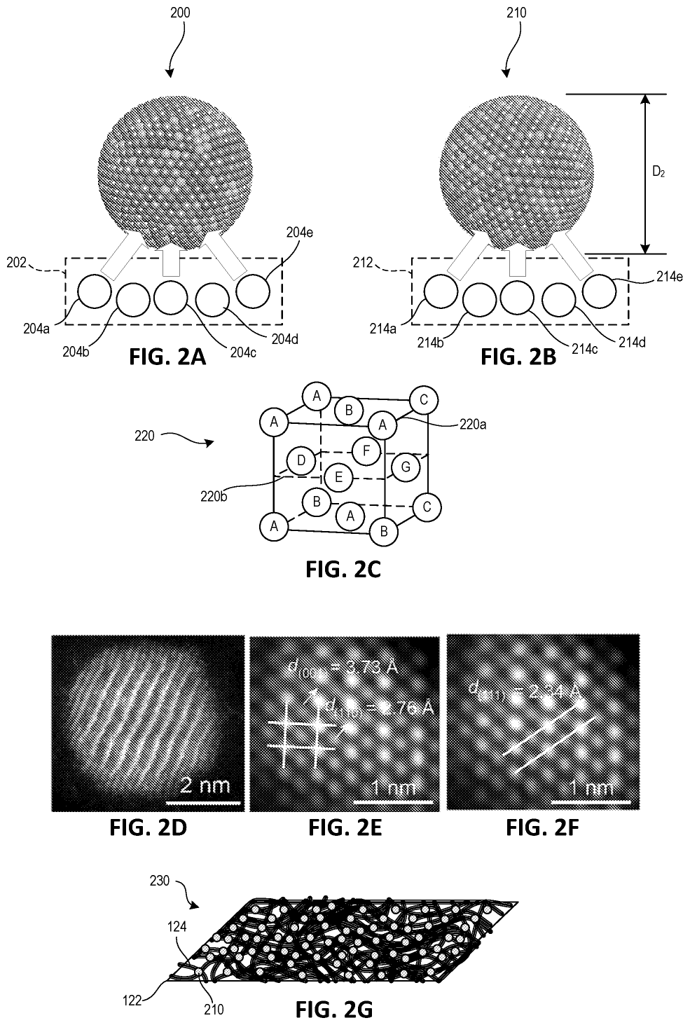

Nanoparticle: An engineered particle formed of a plurality of elements (e.g., at least two (2) elements, for example, at least three (3) elements, at least five (5) elements, or at least eight (8) elements) and having a maximum cross-sectional dimension (e.g., diameter when the particle is spherical, such as D₁ in FIG. 1B or D₂ in FIG. 2B) less than or equal to 1 μm, for example, about 100 nm or less. In some embodiments, each nanoparticle has a maximum cross-sectional dimension of about 20-25 nm. In other embodiments, each nanoparticle has a maximum cross-sectional dimension of 10 nm or less, for example, about 3-6 nm.

Multi-element compound (MEC) nanoparticle: A nanoparticle having a plurality of sites comprising one or more elements, each site forming a compound bond with at least one other site. In some embodiments, the compound bond is a covalent bond, an ionic bond, and/or a metallic bond. In some embodiment, an MEC nanoparticle is a multi-element oxide (MEO) nanoparticle, a multi-element carbide (ME-carbide) nanoparticle, a multi-element intermetallic (MEI) nanoparticle, a multi-element nitride nanoparticle, a multi-element amorphous glass nanoparticle, a multi-element diboride nanoparticle, a multi-element phosphide nanoparticle, a multi-element sulfide nanoparticle, a multi-element chalcogenide nanoparticle, or a multi-element silicide nanoparticle.

Phase separation: A nanoparticle or other structure where two or more distinct phases arise from a single homogeneous phase or mixture.

### Introduction

Embodiments of the disclosed subject provide multi-element compound (MEC) nanoparticles having at least three different elements without phase separation (e.g., a single phase exhibiting a single crystal structure, e.g., a single solid solution) and high-temperature techniques for fabrication (also referred to herein as synthesis or making) thereof. Each multi-element compound nanoparticle can have at least three elements, e.g., AₓB_{y},C_{z}, where A, B, and C represent the different elements (e.g., one or more metals, one or more non-metals, or any combination of the foregoing) in the molecular compound, and x, y, and z represent the number of atoms of the respective element in the molecular compound. In some embodiments, the MEC nanoparticle is comprised of a plurality of sites, with at least one atom of one of the elements at each site (e.g., Site A, Site B, Site C, etc.). Each site can form a compound bond with at least one other site in the nanoparticle.

In order to fabricate the MEC nanoparticles, high temperatures can be used to drive decomposition of precursors and subsequent multi-elemental mixing and compound formation. However, the temperature application can be precisely controlled to avoid structural deterioration and particle aggregation, for example, by tailoring the heating profile to apply a short pulse of high temperature. In some embodiments, the high temperature employed to synthesize the MEC nanoparticles can be in a range of, for example, 500 K to 4000 K, inclusive, (e.g., 1000-2000 K, inclusive) and the duration of the high temperature can be in a range of, for example, 1 millisecond (ms) to 1 second (s), inclusive (e.g., 10-100 ms, inclusive). The transition to/from the high temperature may be achieved relatively quickly, for example, a heating rate and/or a cooling rate in a range of 10 K/minute to 10⁷ K/minute, inclusive. In some embodiments, additional heating at a same or different temperature (e.g., 2000 K or greater) and/or longer duration (e.g., 1-10 minutes) can be subsequently administered to achieve nanoparticles of different compositions and/or material properties.

Such MEC nanoparticles can exhibit a stable structure due, at least in part, to (1) the compound formation structure with a strong covalent bond and/or (2) the high mixing entropy that can thermodynamically and kinetically improve the structural stability. In addition, the rapid synthesis capabilities enabled by the disclosed techniques can enable high-throughput screening of element combinations for suitability in particular applications. In some embodiments, artificial intelligence (AI) (e.g., machine learning) can be used in conjunction with the disclosed techniques to fabricate and evaluate different MEC nanoparticle compositions for a particular application, as well as to optimize properties of MEC nanoparticles (e.g., by changing fabrication parameters, such as, heating temperature, temperature duration, heating ramp speed, cooling ramp speed, etc.).

In some embodiments, MEC nanoparticles may be especially useful as catalysts for thermochemical reactions and/or electrochemical reactions. For example, thermochemical reactions can include, but are not limited to, ammonia (NH₃) synthesis or decomposition, methane (CH₄) pyrolysis and conversion, carbon dioxide (CO₂) methanation and conversion, coal gasification, water-gas shift reactions, syngas conversion reactions, or any combination of the foregoing. For example, electrochemical reactions can include, but are not limited to, water splitting (e.g., hydrogen and oxygen evolutions), fuel cell applications (e.g., hydrogen oxidation and oxygen reduction reactions), CO₂ reduction reactions, nitrogen (N₂) reduction reactions, or any combination of the foregoing.

### Multi-Element Oxide (MEO) Nanoparticles and MEO Nanoparticle Structures

As noted above, conventional fabrication techniques are unable to produce multi-element nanoparticles having a single phase. Rather, as shown in FIG. 1A, a conventional nanoparticle 100 formed of at least two different elements 102, 104 results in clear phase separation. In contrast, MEC nanoparticles fabricated according to the disclosed techniques are capable of combining multiple different elements into a compound nanoparticle having a single homogeneous oxide phase. For example, FIG. 1B, shows an exemplary multi-element oxide (MEO) nanoparticle 110 formed from the combination of oxygen (O) 112 and at least three different cations 118a-118c. In some embodiments, one, some, or all of the cations 118a-118c can be selected from a group 116 of metals, for example, alkali metals, alkaline earth metals, lanthanoids, actinoids, transition metals, or post-transition metals. For example, in some embodiments, at least one cation 118a-118c of the group 116 can be a transition metal, and at least another cation 118a-118c of the group 116 can be a noble metal (e.g., Ru, Rh, Pd, Ag, Re, Os, Ir, Pt, and Au). In some embodiments, the MEO nanoparticle 110 can have a maximum cross-sectional dimension (e.g., diameter), D₁, of about 20-25 nm.

In some embodiments, the MEO nanoparticle 110 can have a configurational entropy greater than that of conventional oxide nanoparticle 100. In general, configurational entropy can increase with the number of cations, and the number of cations may be limited to less than or equal to five due to limitations with conventional fabrication processes. Configurational entropy ΔS_{config}) can be calculated for MEO materials (e.g., fluorite oxides (MO₂), in which M is the cationic element) by:

ΔS_{config}=−R*(Σᵢ₌₁ⁿxᵢlnxᵢ)_{M-site} (1)

where R is the gas constant, xᵢ represents the mole fractions of the metal cations, M-site refers to the cationic site, and n is the total number of cations. For example, the configurational entropy of conventional oxide nanoparticles may be lower than 13.38 J/mol/K (e.g., for 5 cations), while E nanoparticles fabricated according to embodiments of the disclosed subject matter can demonstrate configurational entropy in excess of 13.5 J/mol/K, e.g., about 19.14 J/mol/K for an E nanoparticle with 10 cations. In some embodiments, such increased entropy can enhance the structural stability of the E nanoparticles, for example, when exposed to harsh environments in certain applications.

In some embodiments, a plurality of MEC nanoparticles 110 can be supported on and/or integrated with a substrate to form a structure (e.g., catalytic structure). In some embodiments, the substrate can be the same structure used to initially form the nanoparticles from a plurality of precursors (e.g., metal salts) loaded thereon and subsequently heated. For example, in some embodiments, the substrate can be a carbon-based structure and can serve as the heating element for the disclosed precision control heating (e.g., thermal shock process). Alternatively or additionally, the substrate can be disposed in thermal communication (e.g., conductive, convective, or radiative) with a heating element that provides the desired thermal shock to convert the precursors into a plurality of separated nanoparticles (e.g., with a minimum spacing between adjacent nanoparticles 110 varying from −10 nm to −100 nm).

Referring to FIG. 1C, a simplified illustration of an exemplary catalytic structure 120 is shown. In the illustrated example, the catalytic structure 120 has a substrate 122 (e.g., carbon-based structure) with a random arrangement of MEO nanoparticles 110 with substantially the same composition. For example, in some embodiments, the substrate 122 can be formed of a network of carbon nanofibers (CNFs) 124, as shown in FIG. 1C. The MEO nanoparticles 110 can be formed directly on surfaces of the CNFs 124. Thus, some of the MEO nanoparticles 110 may be disposed within the CNF network, while others may be considered disposed on an externally-facing surface of the CNF network (e.g. substrate 122). The resulting catalytic structure 120 can be considered porous, such that a flow of reactants can be directed perpendicular to substrate 122 (e.g., to allow the reactants to contact nanoparticles 110 within the CNF network). Alternatively or additionally, reactants can be directed substantially parallel to a main or active external surface of the substrate 122.

In FIG. 1C, substrate 122 is generally shaped as a rectangular prism. However, in some embodiments, the substrate can have a shape different than that illustrated in FIG. 1C (e.g., film, membrane, polyhedral prism, irregular-shaped structure, particle, etc.) and/or an arrangement of EO nanoparticles 110 different than that illustrated in FIG. 1C (e.g., a regular array of MEO nanoparticles on exposed surfaces of the substrate). For example, in some embodiments, the substrate used to form and/or subsequently support MEO nanoparticles can include CNFs, carbon nanotubes (CNTs), mesoporous carbon molecular sieves (CMK), carbon paper, carbon felt, carbon black powder or particle, graphite powder or particle, graphene, carbonized wood, a semiconductor, a textile, a metal, a dielectric, an oxide, or any combination of the foregoing.

In some embodiments, the use of the rapid, non-equilibrium techniques described herein allows for the synthesis of MEO nanoparticles having a single-phase structure and uniform dispersion. The non-equilibrium synthesis features rapid high-temperature heating, which promotes multi-element mixing to form MEOs, while the short heating duration effectively avoids particle aggregation and oxide reduction. In some embodiments, because of the differences between elements for the E nanoparticle (e.g., oxidation potential, cation radii, crystal structure, etc.), the heating may be done in the presence of an oxygen partial pressure and/or additional elements can be added to increase the entropy, to allow synthesis of unique EO nanoparticles with customized structures that would otherwise not be possible with conventional techniques.

TABLE 1A
Exemplary compositions for forming MEO nanoparticles

| | Rock-Salt Structure | Spinel structure | Rutile structure |
|---|---|---|---|
| MEO Nanoparticles | (AO) | (A₃O₄) | (AO₂) |
| Element Choice | A₁ = Mg, Ca, Mn, Ba, Sr | A₁ = Fe, Co, Mn | A = Ti, Pb, V, Mn, Cr |
| | A₂ = Ni, Fe, Co, Cu, Zn | A₂ = Cr, Ni, Cu | |
| Binary | (A₁A₁)O | (A₁A₁)₃O₄ | (AA)O₂ |
| Ternary | (A₁A₁A₁)O | (A₁A₁A₁)₃O₄ | (AAA)O₂ |
| Quaternary | (A₁A₁A₁A₁)O | (A₁A₁A₁A₂)₃O₄ | (AAAA)O₂ |
| Quinary | (A₁A₁A₁A₁A₂)O | (A₁A₁A₁A₁A₂)₃O₄ | (AAAAA)O₂ |

TABLE 1B
Exemplary compositions for forming MEO nanoparticles

| MEO | Fluorite structure | Tungsten bronze | Perovskite structure |
|---|---|---|---|
| Nanoparticles | (AO₂) | structure (A × B₁₀O₃₀) | (ABO₃) |
| Element | A₁ = Zr, Ce, Hf, La, Y, Gd, Nd, | A = Ca, Sr, Ba, Pb, Li, | A = Ba, Ca, Mg, La, Sr |
| Choice | Pr, Er, Sm, Dy, Eu | Na, K, Mg | B = Ti, Zr, Hf, Sn, Nb, Ta, |
| | A₂ = Cr, Mn, Fe, Co, Pd | B = Nb, Ta, Ti | Mn |
| Binary | (A₁A₁)O₂ | A × B₁₀O₃₀ | ABO₃ |
| Ternary | (A₁A₁A₁)O₂ | (AA) × B₁₀O₃₀ | A(BB)O₃ |
| Quaternary | (A₁A₁A₁A₁)O₂ | (AAA) × B₁₀O₃₀ | (AA)(BB)O₃ |
| Quinary | (A₁A₁A₁A₁A₁)O₂ | (AAA) × (BB)₁₀O₃₀ | (AA)(BBB)O₃ |
| Denary | (A₁A₁A₁A₁A₁A₁A₁A₁A₁A₂)O₂ | (AAAAAAA) × (BBB)₁₀O₃₀ | (AAAAA)(BBBBB)O₃ |

Tables 1A-1B provide exemplary compositions for MEO nanoparticles having different crystal structures. As an example, a denary MEO nanoparticle (e.g., (Zr,Ce,Hf,Ti,La,Y,Gd,Ca,Mg,Mn)O₂₋ₓ, denoted as 10-MEO-MgMn, where x represents oxygen vacancy) was fabricated, for example, by heating a substrate coated with precursors at about 1500-1550 K for about 50 ms. Scanning electron microscopy (SEM) imaging after fabrication revealed the formation of homogenous and high-density nanoparticles 110 on the CNFs 124 of the substrate, as shown in FIGS. 1D-1E.

In some embodiments, fabricated E nanoparticles can be further processed to yield nanoparticles with a different composition. For example, a multi-element carbide (ME-carbide) nanoparticle can be directed from the reaction of a MEO nanoparticle with carbon. In some embodiments, the ME-carbide nanoparticle can be a carbide compound of three or more metal elements covalently bonded with carbon. The different elements in the ME-carbide nanoparticle can be randomly distributed with high entropy.

In some embodiments, the ME-carbide nanoparticle can be formed by enclosing (partially or fully) the MEO nanoparticle with a coating containing at least carbon (C) and then subjecting the coated MEO nanoparticle to further heating (e.g., carbonization), as described in further detail elsewhere herein. For example, the coating may be a polymer comprising C, oxygen (O), and hydrogen (H), such as, but not limited to, polyvinyl alcohol (PVA), polyvinylpyrrolidone (PVP), polyvinylidene difluoride (PVDF), polytetrafluoroethylene (PTFE), or any combination of the foregoing. Since the ME-carbide nanoparticle is directly derived from the reaction of the MEO nanoparticle with C, the ME-carbide has a composition space similar to that of the MEO nanoparticles. In addition to the examples noted above in Tables 1A-1B, Table 2 presents additional exemplary compositions for ME-carbide nanoparticles.

TABLE 2
Exemplary compositions for forming multi-element carbide nanoparticles

| ME-carbide | | |
|---|---|---|
| Nanoparticles | Chemical Formula | Composition |
| Unary | (a)C | a: Ti, Zr, V, Nb, Mo, Hf, Ta, W, Cr |
| Binary | (a, b)C | a ≠ b: Ti, Zr, V, Nb, Mo, Hf, Ta, W, Cr |
| Ternary | (a, b, c)C | a ≠ b ≠ c: Ti, Zr, V, Nb, Mo, Hf, Ta, W, Cr |
| Quaternary | (a, b, c, d)C | a ≠ b ≠ c ≠ d: Ti, Zr, V, Nb, Mo, Hf, Ta, W, Cr |
| Quinary | (a, b, c, d, e)C | a ≠ b ≠ c ≠ d ≠ e: Ti, Zr, V, Nb, Mo, Hf, Ta, W, Cr |
| >Quinary | (a, b, c, d, e, f, . . .)C | Any combination of Ti, Zr, V, Nb, Mo, Hf, Ta, W, Cr |

### Multi-Element Intermetallic (MEI) Nanoparticles and MEI Nanoparticle Structures

In some embodiments, a multi-metal disordered (MMD) nanoparticle can be converted into a multi-element intermetallic (MEI) nanoparticle having long-range order (LRO). The MMD nanoparticle can comprise at least three different metals, for example, formed by applying a heating pulse (e.g., ≥1000 K for 10-100 ms) to metal precursors on a substrate. In some embodiments, the MMD nanoparticle can have five or more different metals and thus may be considered a high-entropy alloy (HEA) nanoparticle. For example, FIG. 2A shows an HEA nanoparticle 200 formed of a plurality of metals 202, e.g., at least five different elements 204a-204e, which form a disordered solid-solution alloy. To form the MEI nanoparticle, the MMD nanoparticle can be subjected to a second heating (e.g., an annealing or ordering heating period) for a longer duration than the heating pulse used to form the MMD nanoparticle. The second heating can be at a same temperature as the MMD-forming heating pulse or at a different temperature (e.g., less than or greater than the MMD-forming heating pulse). In some embodiments, the MMD nanoparticle can be converted to the MEI nanoparticle by application of heating for a period that is at least two orders of magnitude greater than the MMD-forming heating pulse, for example, ≥1000 K for 1-10 minutes.

The longer duration annealing can allow atoms in the MMD to rearrange to a more thermodynamically stable intermetallic configuration (e.g., a disorder-to-order transition), followed by rapid cooling (e.g., at least 10⁴ K/s) to lock the final ordered structure in place. For example, FIG. 2B shows an exemplary MEI nanoparticle 210 formed by annealing an MMD-nanoparticle (e.g., the HEA nanoparticle 200 of FIG. 2A). In the illustrated example, MEI nanoparticle 210 is formed of a plurality of metals 212, e.g., at least five different elements 214a-214e, which form a single solid-solution phase having LRO. When formed from MMD nanoparticle, the metals 212 of MEI nanoparticle 210 can be the same as metals 202 of MMD nanoparticle (e.g., HEA nanoparticle 200_. In some embodiments, one, some, or all of the elements 214a-214e can be selected from any known metals, for example, alkali metals, alkaline earth metals, lanthanoids, actinoids, transition metals, or post-transition metals. In some embodiments, the MEI nanoparticle 210 can have a maximum cross-sectional dimension (e.g., diameter), D₂, of 10 nm or less (e.g., 3-6 nm, such as 3.5-5 nm).

The MEI nanoparticles 210 can exhibit long-range ordering on two sub-lattices (e.g., a superlattice and a non-superlattice). In some embodiments, the MEI nanoparticle can exhibit an LRO of at least 70%, for example, at least 90% (e.g., about 100%), which can be defined by:

$$L R O = \frac{{I}_{110} / {I}_{111}}{{I}_{110}^{*} / {I}_{111}^{*}} \times 100 \qquad ( 2 )$$

where I₁₁₀ and I₁₁₁ are the peak intensities of the superlattice (110) and non-superlattice (111) diffraction peaks, respectively, and I* is the corresponding peak intensity of a perfectly ordered structure (e.g., LRO=100%). In some embodiments, the MEI nanoparticle can have a geometrically closed-packed phase or a topologically closed-packed phase, the formation of which may depend on material selection and stoichiometry ratios for the nanoparticle. For example, the lattice structure of the geometrically closed-packed phase of the MEI nanoparticle can comprise L1₀ (e.g., tetragonal distortion of the face-centered cubic (fcc) structure), L1₁, L1₂, B₂, etc., and the lattice structure of the topologically closed-packed phase can comprise a Laves phase, a σ phase, a μ phase, etc.

In a binary intermetallic, each sub-lattice can be occupied by a single element. However, with MEI phases having more constituent elements than available sub-lattices, at least one sub-lattice (or both sub-lattices) can have two or more elements occupying the sites thereof. For example, an intermetallic 220 of octonary ABCDEFGH may have a random distribution of elements A, B and C (e.g., Pt, Pd, and Au) on one sub-lattice 220a and a random distribution of elements D, E, F, G, and H (e.g., Fe, Co, Ni, Cu, and Sn) on the second sub-lattice 220b, as illustrated schematically in FIG. 2C. In a fabricated example, an octonary MEI nanoparticle having a composition of (Pt_{0.8}Pd_{0.1}Au_{0.1})(Fe_{0.6}Co_{0.1}Ni_{0.1}Cu_{0.1}Sn_{0.1}) was synthesized. The octonary MEI nanoparticle formed an L1₀ intermetallic structure featuring (001), (110), and (111) planes, with spacing of 3.73, 2.76, and 2.34 Å, respectively, as shown in the STEM images of FIGS. 2D-2F.

In some embodiments, a plurality of MEI nanoparticles 210 can be supported on and/or integrated with a substrate to form a structure (e.g., catalytic structure). In some embodiments, the substrate can be the same structure used to initially form the nanoparticles from a plurality of precursors (e.g., metal salts) loaded thereon (or from previously formed MMD nanoparticles, such as HEA nanoparticles 200) and subsequently heated. For example, in some embodiments, the substrate can be a carbon-based structure and can serve as the heating element for the disclosed precision control heating (e.g., thermal shock process) and/or subsequent annealing for ordering. Alternatively or additionally, the substrate can be disposed in thermal communication (e.g., conductive, convective, or radiative) with a heating element that provides the desired thermal shock and/or annealing for ordering.

Referring to FIG. 2G, a simplified illustration of an exemplary catalytic structure 230 is shown. In the illustrated example, the catalytic structure 230 has a substrate 122 (e.g., carbon-based structure) with a random arrangement of MEI nanoparticles 210 with substantially the same composition. For example, in some embodiments, the substrate 122 can be formed of a network of carbon nanofibers (CNFs) 124, as shown in FIG. 1G. The MEI nanoparticles 210 can be formed directly on surfaces of the CNFs 124. Thus, some of the MEI nanoparticles 210 may be disposed within the CNF network, while others may be considered disposed on an externally-facing surface of the CNF network (e.g. substrate 122). The resulting catalytic structure 120 can be considered porous, such that a flow of reactants can be directed perpendicular to substrate 122 (e.g., to allow the reactants to contact nanoparticles 210 within the CNF network). Alternatively or additionally, reactants can be directed substantially parallel to a main or active external surface of the substrate 122.

In FIG. 2G, substrate 122 is generally shaped as a rectangular prism. However, in some embodiments, the substrate can have a shape different than that illustrated in FIG. 2G (e.g., film, membrane, polyhedral prism, irregular-shaped structure, particle, etc.) and/or an arrangement of MEI nanoparticles 210 different than that illustrated in FIG. 2G (e.g., a regular array of MEI nanoparticles on exposed surfaces of the substrate). For example, in some embodiments, the substrate used to form and/or subsequently support MEI nanoparticles can include CNFs, carbon nanotubes (CNTs), mesoporous carbon molecular sieves (CMK), carbon paper, carbon felt, carbon black powder or particle, graphite powder or particle, graphene, carbonized wood, a semiconductor, a textile, a metal, a dielectric, an oxide, or any combination of the foregoing.

In some embodiments, the use of the two-step heating techniques (e.g., rapid pulse heating to convert precursors into a disordered nanoparticle followed by a longer duration anneal heating to cause a disorder-to-order transition of the nanoparticle) can yield ordered intermetallic nanoparticles with a well-define atomic arrangement, small particle size (e.g., <10 nm), and customized compositions and phase structures (e.g., binary PtFe, ternary PtCoNi, quinary PtFeCoNiCu, octonary PtPdAuFeCoNiCuSn, etc.), which would otherwise not be possible with conventional techniques. Without limitation, further exemplary compositions for MEI nanoparticles according to embodiments of the disclosed subject matter are shown in Table 3.

TABLE 3
Exemplary compositions for forming MEI nanoparticles

| MEI | | |
|---|---|---|
| Nanoparticles | N:M = 1:1 | N:M = 3:1 |
| Binary | N₁M₁ | (N₁)₃M |
| Ternary | (N₁)(M₁)ₓ(M₂)₁₋ₓ | (N₁)₃(M₁)ₓ(M₂)₁₋ₓ |
| Quaternary | (N₁)(M₁)ₓ(M₂)_{y}(M₃)_{1-x-y} | (N₁)₃(M₁)ₓ(M₂)_{y}(M₃)_{1-x-y} |
| Quinary | (N₁)(M₁)ₓ(M₂)_{y}(M₃)_{z}(M₄)_{1-x-y-z} | (N₁)₃(M₁)ₓ(M₂)_{y}(M₃)_{z}(M₄)_{1-x-y-z} |
| Octonary | (N₁)ₘ(N₂)ₙ(N₃)₁₋ₘ₋ₙ | (N₁)ₘ(N₂)ₙ(N₃)₃₋ₘ₋ₙ |
| | (M₁)ₓ(M₂)_{y}(M₃)_{z}(M₄)ₒ(M₅)_{1-x-y-z-o} | (M₁)ₓ(M₂)_{y}(M₃)_{z}(M₄)ₒ(M₅)_{1-x-y-z-o} |

M₁, M₂, M₃, M₄, M₅ can be any of Fe, Co, Ni, Cu, Sn, Bi, and Ti
N₁, N₂, N₃ can be any of Pt, Pd, and Au

### Other Multi-Element Compound (MEC) Nanoparticles and Structures

The techniques disclosed herein can be used to fabricate various types of MEC nanoparticles, such as MEO nanoparticles (e.g., (Ce,Zr,Hf,Ti)O₂), ME-carbide nanoparticles (e.g., Ti,Zr,Mo,V,Nb)C), and MEI nanoparticles (e.g. (FeCoNiCu)Pt). Although the discussion and specific examples presented herein focus on MEO, ME-carbide, and MEI nanoparticles, embodiments of the disclosed subject matter are not limited thereto. Rather, one of skill in the art will readily appreciate that the teachings presented herein can be extended to form other types of MEC nanoparticles, such as, but not limited to multi-element nitride nanoparticles, multi-element diboride nanoparticles, multi-element phosphide nanoparticles, multi-element sulfide nanoparticles, multi-element chalcogenide nanoparticles, multi-element silicide nanoparticles, multi-element amorphous glass nanoparticles, etc. For example, Tables 4A-4B provide exemplary compositions for various other MEC nanoparticles that may also be formed according to embodiments of the disclosed subject matter.

Moreover, although the discussion above and elsewhere herein focuses on certain examples of substantially-spherical MEC nanoparticles, the teachings presented herein can be readily extended to provide variations having different compositions (e.g., various compounds and/or different elements), different sizes (e.g., from atomic compounds to 1 μm in a cross-sectional dimension (e.g., maximum or minimum cross-sectional dimension)), different shapes (e.g., triangle, cylindrical rod, rectangular, etc.), different microstructures, different configurations (e.g. hollow, heterogeneous mixture, core-shell, etc.), or any combination of the foregoing. In some embodiments, the size of the fabricated nanoparticles can be varied, for example, by changing precursor loading, changing the type or configuration of the substrate, changing synthesis conditions (e.g., the pulse temperature and/or duration), or any combination of the foregoing. In some embodiments, the shape of the fabricated nanoparticles can be varied, for example, by changing synthesis conditions (e.g., the pulse temperature and/or cooling rate).

In some embodiments, the microstructure of the fabricated nanoparticles can be varied, for example, by using a step-wise synthesis process (e.g., to form a core-shell structure). In some embodiments, the configuration of the fabricated nanoparticles can be varied, for example, by combining with another substrate and/or nanoparticle.

TABLE 4A
Exemplary compositions for other MEC nanoparticles

| MEC | | | |
|---|---|---|---|
| Nanoparticles | Diborides | Nitrides | Phosphides |
| Binary | (Hf, Zr)B₂ | (Nb, Ta)Nₓ | (Ni, Cu)Pₓ |
| Ternary | (HF, Zr, Ta)B₂ | (Nb, Zr, Al)Nₓ | (Ni, Cu, Zn)Pₓ |
| Quaternary | (Hf, Zr, Ti, Nb)B₂ | (Nb, Ta, Zr, V)Nₓ | (Fe, Ni, Cu, Zn)Pₓ |
| Quinary | (HF, Zr, Ta, V, Nb)B₂ | (Al, Cr, Ti, Nb, Ta)Nₓ | (Fe, Co, Ni, Cu, Zn)Pₓ |

| | |
|---|---|
| General | General compositions Ax, By, Cz. For A, B, and C sites, (1) at least one site is |
| | multi-element mixing; and (2) at least two sites form compound bonds. |

TABLE 4B
Exemplary compositions for other MEC nanoparticles

| MEC | | |
|---|---|---|
| Nanoparticles | Sulfides | Silicides |
| Binary | (Mo, W)Sₓ | (Cr, Mn)Siₓ |
| Ternary | (Mo, W, Co)Sₓ | (Cr, Mn, W)Siₓ |
| Quaternary | (Mo, W, Co, Sn)Sₓ | (Cr, Mn, Mo, W)Siₓ |
| Quinary | (Mo, W, Co, Sn, Ni)Sₓ | (Cr, Mn, Mo, Sb, W)Siₓ |

| | |
|---|---|
| General | General compositions Ax, By, Cz. For A, B, and C sites, (1) at least one site |
| | is multi-element mixing; and (2) at least two sites form compound bonds. |

### Methods for Fabrication of MEO Nanoparticles

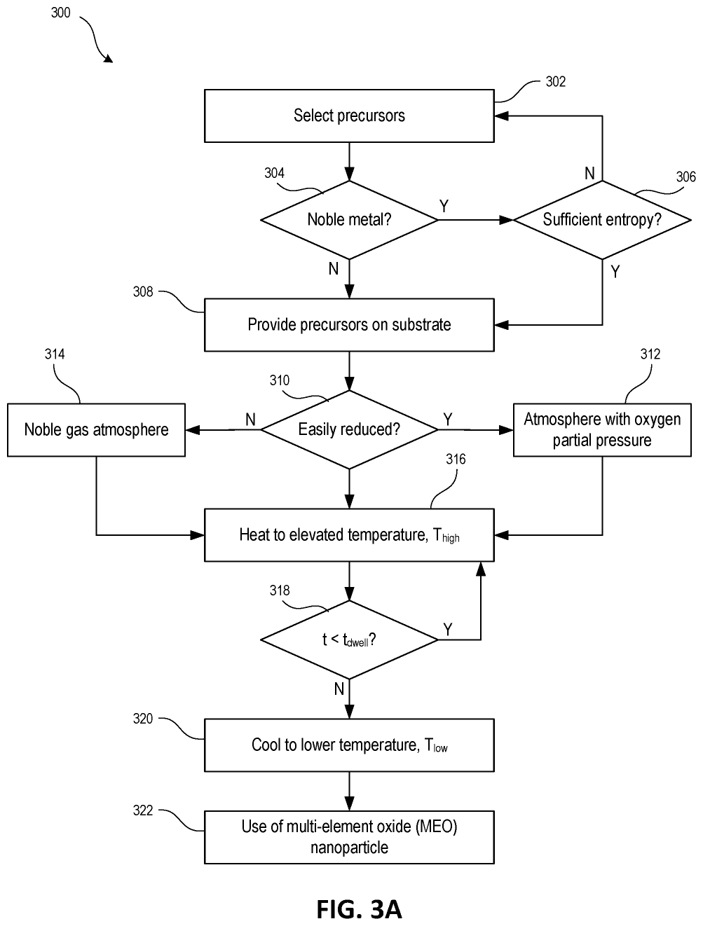

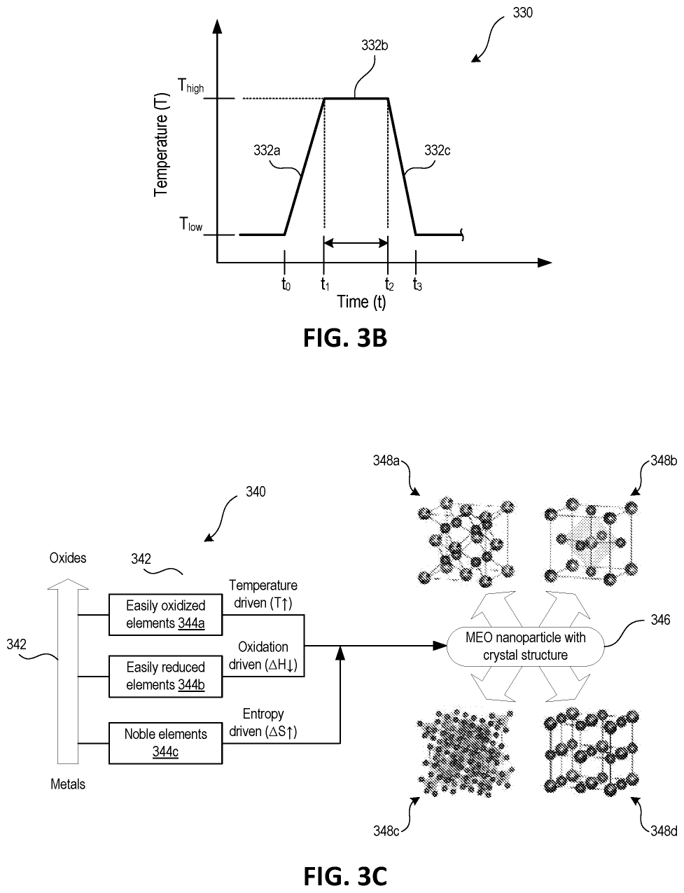

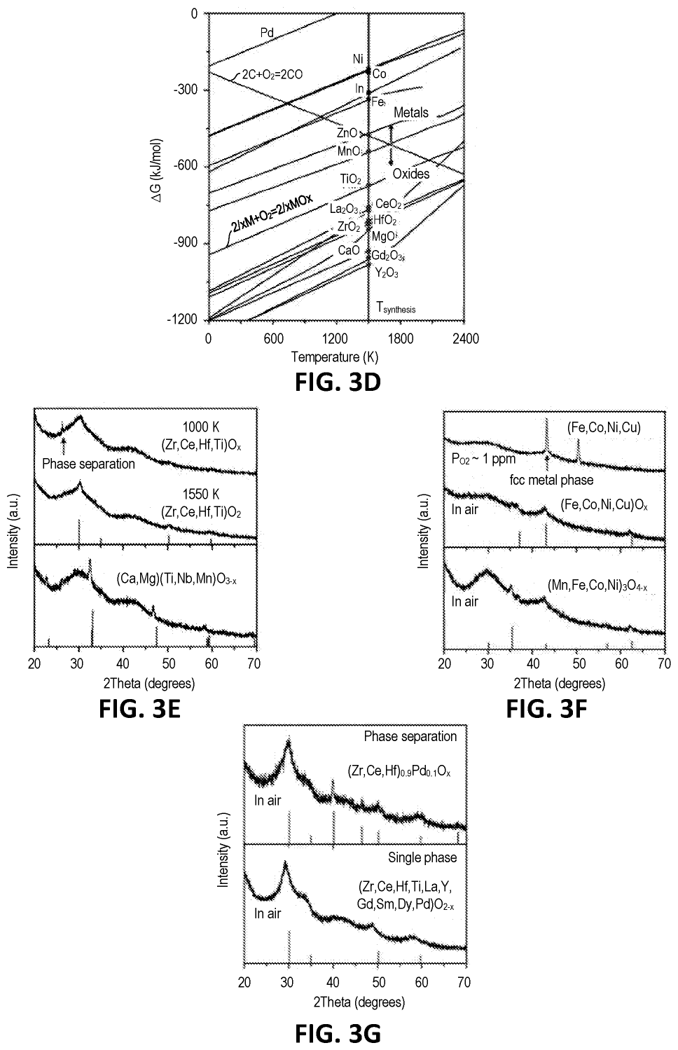

FIG. 3A shows an exemplary method 300 for forming MEO nanoparticles, such as MEO nanoparticle 110 of FIG. 1B and/or structure 120 incorporating MEO nanoparticles of FIG. 1C. The method 300 can initiate at process block 302, where precursors for the multiple elements in the desired MEO nanoparticle are selected. As noted above, each EO nanoparticle can be formed of O in combination with at least three different cations (e.g., metal elements). Thus, in some embodiments, the precursors can include metal salts (e.g., metal chloride salt, metal nitrate hydrate salt, etc.) in solution (e.g., ethanol, water, or a mixture thereof). In some embodiments, at least one of the precursors may include O.

The method 300 can proceed to decision block 304, where it is determined if one of the selected cations is a noble metal. As described in more detail below, the selection of a noble metal may require an additional synthesis strategy to allow proper formation of the EO nanoparticle. If a noble metal is selected, the method 300 can proceed from decision block 304 to decision block 306, where it is further determined if the number of selected constituent elements provides sufficient entropy to enable formation of the MEO nanoparticle. For example, in some embodiments, the inclusion of a noble metal in the MEO nanoparticle may require six or more other metal elements (e.g., at least ten different metals total) for proper formation of the compound oxide. If an insufficient number of elements has been selected, the method 300 can return to process block 302 for the inclusion of additional cations via the selection of additional precursors.

If it is determined that a sufficient number of elements has been selected at decision block 306 or if it is determined that MEO nanoparticle will not include a noble metal at decision block 304, the method 300 can proceed to process block 308, where the selected precursors are loaded onto a substrate. In some embodiments, the loading can be provided by dip coating the substrate in one or more solutions containing the selected precursors, and then drying (e.g., at room temperature). Alternatively or additionally, the loading can be via any other application technique, such as, but not limited to, pouring, brushing, spraying, printing, or rolling the solution onto the substrate. The loading of precursors can mirror the desired composition for the mixture of the resulting of the nanoparticles, for example, such that a desired atomic ratio of cations is attained.

The method 300 can proceed to decision block 310, where it is determined if any of the selected cations are easily reduced (e.g., when exposed to the high temperatures required for particle synthesis, such as 1400-1600 K). If one or more of the cations are easily reduced, the method 300 can proceed to process block 312, where the substrate with precursors is placed in an atmosphere with an oxygen partial pressure for subsequent heating. For example, the substrate can be placed in an atmosphere of ambient air. Alternatively or additionally, the substrate can be placed in an atmosphere containing at least 15% vol. of O (e.g., ˜20.95% vol) and/or having an oxygen partial pressure of at least 150 mbar (e.g., ˜212.3 mbar). Otherwise, if the cations are not easily reduced, the method 300 can proceed from decision block 310 to process block 314, where the substrate is placed in an atmosphere having substantially no oxygen partial pressure (e.g., ≤1 ppm of O) for subsequent heating. For example, the substrate can be placed in an atmosphere of a noble gas, such as argon (Ar).

The method 300 can proceed from either process block 312 or process block 314 to process block 316, where the substrate with precursors thereon is heated to an elevated temperature, T_{high}, in the selected atmosphere. The method 300 can proceed to decision block 318, where it is determined if the substrate has been maintained at the elevated temperature for a predetermined pulse period or dwell time, t_{dwell}. If the predetermined dwell time has not been met, the method 300 can return to process block 316 where the heating is continued to maintain the substrate at the elevated temperature. Otherwise, once the predetermined dwell time has been met, the method 300 can proceed from decision block 318 to process block 320, where the substrate is rapidly cooled to a relatively low temperature, T_{low}.

In some embodiments, blocks 316-320 of method 300 can subject the substrate to a thermal shock process. The thermal shock process can be achieved, for example, by a pulsed heating profile 330, as shown in FIG. 3B. The pulsed heating profile 330 can initiate at relatively low temperature (e.g., <500 K, such as room temperature (e.g., 290-300 K)) and can include (i) a rapid heating ramp 332a (e.g., (T_{high}−T_{low})/(t₁−t₀)≥10⁴ K/s), (ii) a short dwell period 332b (e.g., (t₂−t₁)≤200 ms or ≤100 ms) at or about peak temperature, T_{high} (e.g., ≥1200 K), and (iii) a rapid cooling ramp 332c (e.g., (T_{high}−T_{low})/(t₃−t₂)≥10⁴ K/s). For example, in some embodiments, the peak temperature, T_{high}, of the dwell period 332b can in a range of 1400-1600 K, inclusive (e.g., about 1500-1550 K), for a duration of about 50-55 ms. Alternatively, in some embodiments, the duration of the dwell period 332b can be extended when the peak temperature is lower, for example, about 200 ms for a peak temperature, T_{high}, in a range of 1200-1400 K. In some embodiments, the cooling ramp rate (e.g., about 10⁵ K/s) may be greater than the heating ramp rate (e.g., about 10⁴ K/s).

In some embodiments, the pulsed heating profile can be provided by passing electrical current through the substrate to provide Joule heating. Alternatively or additionally, in some embodiments, the pulsed heating profile can be provided by a separate heating mechanism (e.g., direct Joule heating, conduction heating, radiative heating, microwave heating, laser heating, plasma heating, or any combination of the foregoing) in thermal communication with the substrate and capable of providing the heating profile of FIG. 3B. Further details regarding a thermal shock process, which can be employed in embodiments of the disclosed subject matter, can be found in U.S. Publication No. 2019/0161840, published May 30, 2019, which details are incorporated by reference herein.

Returning to FIG. 3A, the rapid heating of the substrate at process block 316 can induce rapid thermal decomposition and mixing of the precursors thereon, and the subsequent rapid cooling at process block 320 can form the mixed precursors into compound oxide nanoparticles without being subject to aggregation, agglomeration, element segregation, or phase separation. The method 300 can proceed to process block 322, where the resulting MEO nanoparticles can be used in a particular application. For example, in some embodiments, the MEO nanoparticles can be used as the starting material for fabrication of other MEC nanoparticles, such as ME-carbide nanoparticles. Alternatively or additionally, the MEO nanoparticles (with or without the substrate used for fabrication) can be used as a catalyst for thermochemical reactions and/or electrochemical reactions.

Although some of blocks 302-322 of method 300 have been described as being performed once, in some embodiments, multiple repetitions of a particular process block may be employed before proceeding to the next decision block or process block. In addition, although blocks 302-322 of method 300 have been separately illustrated and described, in some embodiments, process blocks may be combined and performed together (simultaneously or sequentially). Moreover, although FIG. 3A illustrates a particular order for blocks 302-322, embodiments of the disclosed subject matter are not limited thereto. Indeed, in certain embodiments, the blocks may occur in a different order than illustrated or simultaneously with other blocks.

Metallic elements can have a wide range of oxidation potentials at a high temperature (e.g., according to the Ellingham diagram) that could otherwise lead to sequential phase separation or metallic impurities in a multi-elemental system (e.g., a failure of uniform mixing). Accordingly, as noted above, the method 300 can employ different synthesis strategies based on the desired composition of the ultimate MEO nanoparticle, for example, based on the Gibbs free energy of the system (ΔG=ΔH−T×ΔS). Indeed, since oxide materials feature more complex elemental combinations than pure metals, the formation of single-phase MEO nanoparticles requires meticulous design and synthesis guidelines. The choice of elements for the MEO nanoparticle can be important as some, such as Ni, Cu, and Pd, can be reduced to metals at high temperatures or by the reduction conditions (e.g., carbon and 5% H₂/Ar). The oxide formation potential for an element can be evaluated by the Ellingham diagram, which illustrates the formation Gibbs free energy (ΔG) of oxides at high temperature, as shown in FIG. 3D.

Using the Ellingham diagram as a guide, unary nanoparticles were synthesized for 24 individual elements that can form stable oxide nanoparticles using the disclosed thermal shock method. After this initial single-element screening, the elements were divided into three categories: easily oxidized elements (e.g., Y, Ca, Ti, Zr), easily reducible elements (e.g., Ni, Cu, Fe), and noble elements (e.g., Pd). FIG. 3C is a schematic 340 illustrating aspects of exemplary element classifications 344a-344c and associated strategies for producing single-phase MEO nanoparticles 346 with assorted structures (e.g., fluorite 348a, perovskite 348b, spinel 348c, rock-salt 348d) from elements having different oxidation potentials 342. By employing these strategies (alone or in combination, based on the constituent elements of the nanoparticle), the Gibbs free energy, ΔG, can be reduced, thereby favoring the formation of single-phase MEO nanoparticles.

A first classification 344a can be assigned to elements that are determined to be easily oxidized (e.g., via experimental testing of the separate elements), and temperature-driven mixing (e.g., synthesis temperature, T_{high}, increased) can be used to form MEO nanoparticles therefrom. For example, the temperature-driven mixing can be produced by subjecting the elements to a thermal shock (e.g., 1200-1600 K for ≤200 ms, such as ˜1500 K for 55 ms). For example, as shown in FIG. 3E, phase separation was observed in the X-ray powder diffraction (XRD) pattern of (Zr,Ce,Hf,Ti)Oₓ nanoparticles synthesized at ˜1000 K; however, by increasing the synthesis temperature to ˜1550 K, a single-phase fluorite structure was successfully achieved. Senary oxide (Zr,Ce,Hf,Ti,La,Y)O₂₋ₓ, denary oxide (Zr,Ce,Hf,Ti,La,Y,Gd,Ca,Mg,Mn)O₂₋ₓ (fluorite), denary oxide (Zr,Ce,Hf,Ti,La,Y,V,Nb,Ca,Mn)O₂₋ₓ(fluorite), and quinary oxide (Ca,Mg)(Ti,Nb,Mn)O₃₋ₓ (perovskite) nanoparticles were also successfully synthesized in this manner, in which the XRD patterns of FIG. 3E, STEM atomic imaging, and TEM mapping confirm the single-phase structures of these materials.

A second classification 344b can be assigned to elements that are determined to be easily reduced (e.g., via experimental testing of the separate elements), and oxidation-driven mixing (e.g., mixing enthalpy, ΔH, decreased) can be used to form MEO nanoparticles therefrom. For example, the oxidation-driven mixing can be produced by increasing the oxygen partial pressure (P_{O2}) (e.g., from −1 ppm of oxygen to an oxygen partial pressure of ˜212.3 mbar) during the thermal shock synthesis. For example, homogenous oxide (Fe,Co,Ni,Cu)Oₓ nanoparticles featuring a rock-salt structure can be formed from precursors containing Fe, Co, Ni, and Cu by conducting the synthesis in air (e.g., a high P_{O2}), as confirmed by the XRD patterns of FIG. 3F, STEM atomic imaging, and TEM elemental mapping. By contrast, when a similar synthesis was done in an argon-filled glovebox (e.g., a low P_{O2} of −1 ppm), a face-centered cubic (fcc) metal structure was observed, as shown in FIG. 3F. Quaternary oxide (Mn,Fe,Co,Ni)₃O₄₋ₓ (spinel structure) and quinary (Mg,Co,Ni,Zn,Cu)O nanoparticles (rock-salt structure) were also successfully synthesized in this manner.

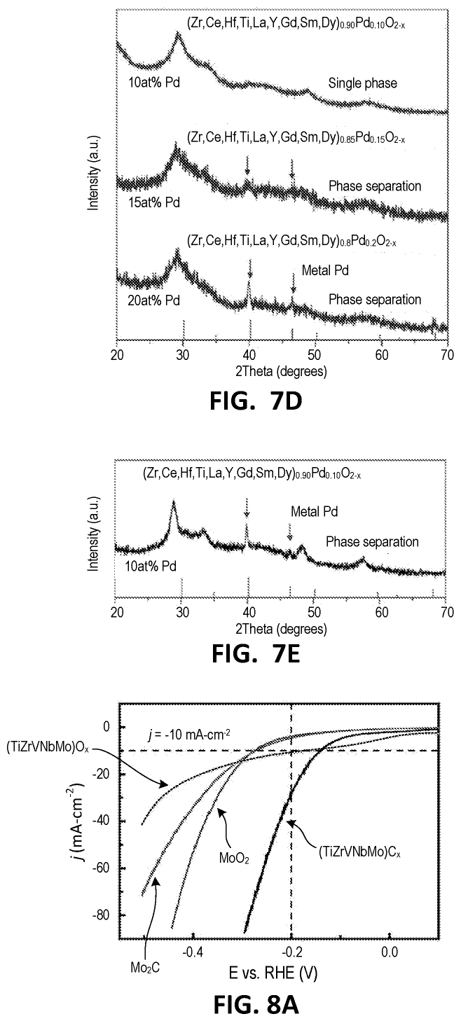

A third classification 344c can be assigned to elements that are noble metals (e.g., Ru, Rh, Pd, Ag, Re, Os, Ir, Pt, and Au), and entropy-driven mixing (e.g., increasing mixing entropy, ΔS) can be used to form MEO nanoparticles therefrom. For example, the entropy-driven mixing can be produced by increasing the number of elements (e.g., 10 cations) to enable the inclusion and stabilization of the noble metal in the MEO nanoparticle. For example, phase separation of the Pd metal and oxides in (Zr,Ce,Hf)_{0.9}Pd_{0.1}Oₓ synthesized at high temperature (˜1500 K) in air can be observed, as shown in FIG. 3G. However, by adding six more cations to the composition, the entropy is effectively increased, thereby allowing formation of 10-element MEO nanoparticles containing Pd (˜10 at %) in its oxidized state, as shown in FIG. 3G. Such a composition would otherwise lead to phase separation of metallic Pd if synthesized using conventional heating methods (e.g., as shown in FIGS. 7D-7E). A similar result was achieved for the stabilization of oxidized Rh in denary MEOs.

### Methods for Fabrication of ME-Carbide Nanoparticles

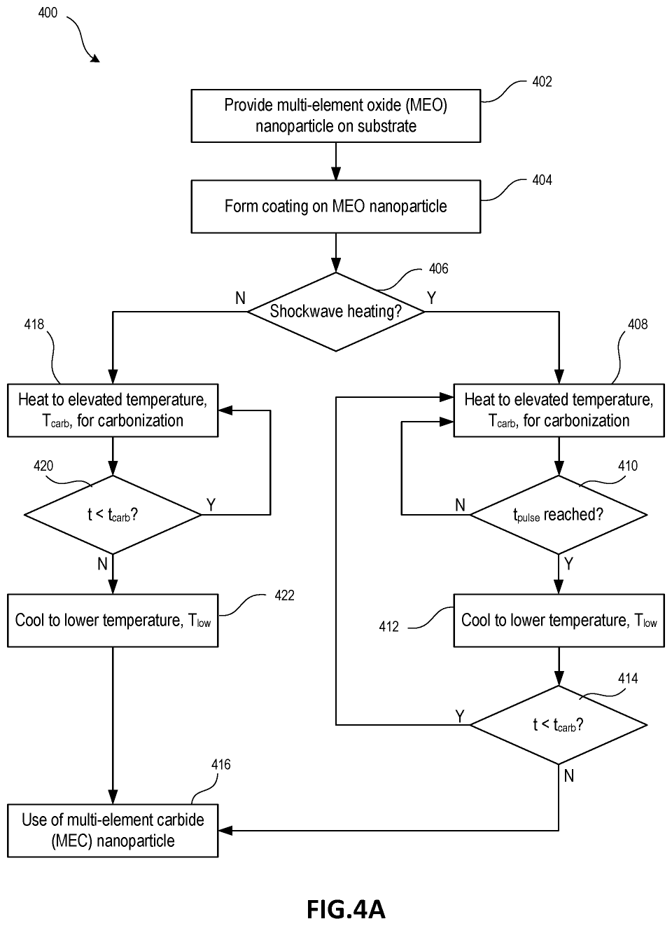

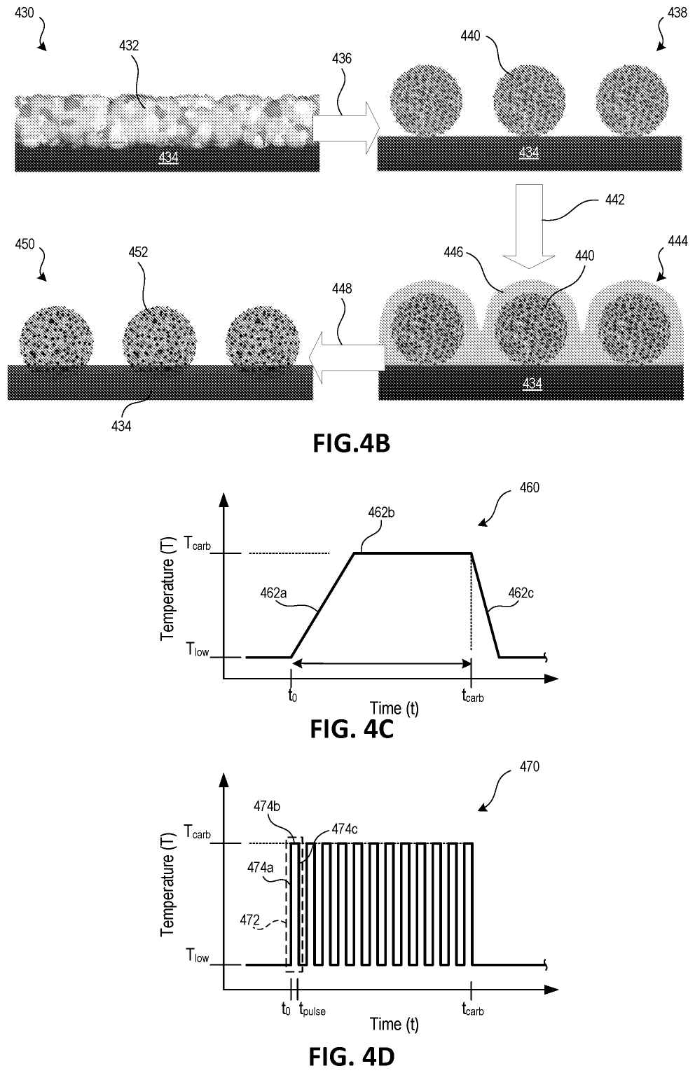

FIG. 4A shows an exemplary method 400 for forming ME-carbide nanoparticles. The method 400 can initiate a process block 402, where MEO nanoparticles are provided on a substrate. For example, the MEO nanoparticles can be formed on the substrate via method 300 of FIG. 3A and subsequently provided for separate conversion to ME-carbide nanoparticles. Alternatively, in some embodiments, the methods of FIGS. 3A and 4A can be combined, for example, by replacing process block 402 of method 400 in FIG. 4A with blocks 302-320 of method 300 in FIG. 3A.

The method 400 can proceed to process block 404, where a carbon source is formed on the MEO nanoparticles as a thin layer or coating (e.g., having a thickness equal to or less than a maximum cross-sectional dimension of the MEO nanoparticles). For example, the carbon-source coating can at least partially surround or enclose the MEO nanoparticles (e.g., all exterior surfaces of the MEO nanoparticles exposed from the substrate). In some embodiments, the substrate can act as an additional carbon source (e.g., CNF, carbon nanotube (CNT), mesoporous carbon molecular sieve (CMK), carbon paper, carbon felt, carbon black powder or particle, graphite powder or particle, graphene, carbonized wood, etc.) such that the combination of the coating and the substrate completely surround each MEO nanoparticle and isolate the MEO nanoparticles from adjacent MEO nanoparticles. In some embodiments, the carbon-source coating can comprise at least carbon (C), and may also comprise oxygen (O) and/or hydrogen (H). For example, the coating can comprise a polymer, such as, but not limited to, polyvinyl alcohol (PVA), polyvinylpyrrolidone (PVP), polyvinylidene difluoride (PVDF), and/or polytetrafluoroethylene (PTFE). In some embodiments, the coating can be applied by pouring a polymer-alcohol solution onto the substrate and subsequently drying (e.g., in air). Alternatively or additionally, the coating can be applied via any other application technique, such as, but not limited to dip coating, brushing, spraying, printing, rolling, depositing, in situ polymerization of precursors, etc.

The method 400 can proceed to decision block 406, where the heating profile for carbonization can be selected. For example, if shockwave heating is desired, the method 400 can proceed to process block 408, where the substrate with MEO nanoparticles thereon is heated to an elevated temperature, T_{carb}, which may be the same as or different (e.g., higher or lower) than the elevated temperature, T_{high}, used to form the MEO nanoparticles. The method 400 can proceed to decision block 410, where it is determined if the substrate has been maintained at the elevated temperature for a predetermined pulse period or dwell time, tₚᵤₗₛₑ. If the predetermined pulse period has not been met, the method 400 can return to process block 408, where the heating is continued to maintain the substrate at the carbonization temperature. Otherwise, once the predetermined pulse period has been met, the method 400 can proceed from decision block 410 to process block 412, where the substrate is rapidly cooled to a relatively low temperature, which may be the same as or different (e.g., higher or lower) than the low temperature, T_{low}, used to form the MEO nanoparticles. The method 400 can proceed to decision block 414, where it is determined if the total heating time required for carbonization, t_{carb}, has been met. If the total heating time has not been met, the method 400 can return to process block 408 for repeated application of the heating pulse.

In some embodiments, blocks 408-414 of method 400 can subject the substrate to a thermal shockwave process. The thermal shockwave process can be achieved, for example, by a multi-pulse heating profile 470, as shown in FIG. 4D. The multi-pulse heating profile 470 can be comprised of multiple individual pulses 472, each of which can be of substantially-identical shape and/or duration. Each individual pulse 472 can initiate at relatively low temperature (e.g., <500 K, such as room temperature (e.g., 290-300 K)) and can include (i) a rapid heating ramp 474a (e.g., ≥10⁴ K/s), (ii) a short dwell period 474b (e.g., 10 ms to 1 s, inclusive) at or about carbonization temperature, T_{carb} (e.g., 1500-3000 K), and (iii) a rapid cooling ramp 474c (e.g., ≥10⁴ K/s). For example, in some embodiments, the carbonization temperature, T_{carb}, of each dwell period 474b can be greater than the peak temperature, T_{high} (e.g., about 2000 K for T_{carb} versus about 1500 K for T_{high}) used for MEO nanoparticle formation. In some embodiments, the period of each pulse, tₚᵤₗₛₑ, can be similar to the dwell time, t_{dwell}, used for EO nanoparticle formation, for example, about 50-55 ms. The heating profile 470 can apply individual pulses 472 in sequence until a total time for carbonization, t_{carb}, has been reached. For example, the total time, t_{carb}, can be about 1-2 minutes (e.g., repetition of pulse 472 in a range of 10-100 times, inclusive).

Returning to FIG. 4A, if shockwave heating is not desired at decision block 406, the method 400 can proceed to process block 418, where the substrate with MEO nanoparticles thereon is heated to an elevated temperature, T_{carb}. The method 400 can proceed to decision block 420, where it is determined if the total heating time required for carbonization, t_{carb}, has been met. If the carbonization time has not been met, the method 400 can return to process block 418, where the heating is continued to maintain the substrate at the carbonization temperature. Otherwise, once the carbonization time has been met, the method 400 can proceed from decision block 420 to process block 422, where the substrate is rapidly cooled to a relatively low temperature, e.g., T_{low}.

In some embodiments, blocks 418-422 of method 400 can subject the substrate to a continuous annealing for carbonization. The continuous annealing can be achieved, for example, by the heating profile 460, as shown in FIG. 4C. The heating profile 460 can initiate at relatively low temperature (e.g., <500 K, such as room temperature (e.g., 290-300 K)) and can include (i) a heating ramp 462a (e.g., <10⁴ K/s), (ii) an extended dwell period 462b (e.g., 1-2 minutes, inclusive) at or about carbonization temperature, T_{carb} (e.g., 1500-3000 K), and (iii) a rapid cooling ramp 474c (e.g., ≥10⁴ K/s). For example, in some embodiments, the carbonization temperature, T_{carb}, of dwell period 462b can be greater than the peak temperature, T_{high} (e.g., about 2000 K for T_{carb} versus about 1500 K for T_{high}) used for MEO nanoparticle formation. In some embodiments, the heating ramp 462a rate can be at least an order of magnitude slower than that used for MEO nanoparticle formation, and/or the cooling ramp 462c rate can be substantially the same as that used for MEO nanoparticle formation.

Returning to FIG. 4A, in either of process blocks 408 or 418, the respective heating profile can be provided by passing electrical current through the substrate to provide Joule heating. Alternatively or additionally, in some embodiments, the heating profile can be provided by a separate heating mechanism (e.g., direct Joule heating, conduction heating, radiative heating, microwave heating, laser heating, plasma heating, or any combination of the foregoing) in thermal communication with the substrate and capable of providing the heating profile of FIG. 4C or 4D. In some embodiments, during high temperature application, the coating can be converted into carbon (e.g., amorphous carbon), thereby acting as a carbon source for ME-carbide formation. The method 400 can proceed from process block 422 or from decision block 414 to process block 416, where the resulting MEC nanoparticles can be used in a particular application. For example, in some embodiments, the MEC nanoparticles (with or without the substrate used for fabrication) can be used as a catalyst for thermochemical reactions and/or electrochemical reactions.

Although some of blocks 402-422 of method 400 have been described as being performed once, in some embodiments, multiple repetitions of a particular process block may be employed before proceeding to the next decision block or process block. In addition, although blocks 402-422 of method 400 have been separately illustrated and described, in some embodiments, process blocks may be combined and performed together (simultaneously or sequentially). Moreover, although FIG. 4A illustrates a particular order for blocks 402-422, embodiments of the disclosed subject matter are not limited thereto. Indeed, in certain embodiments, the blocks may occur in a different order than illustrated or simultaneously with other blocks.

Referring to FIG. 4B, an exemplary two step heating process for fabrication of MEC nanoparticles is shown. Metal salt precursors 432 can be uniformly loaded onto a substrate 434 to form an initial assembly 430. For example, the metal salts can be dissolved in an organic solvent (e.g., methanol, ethanol, dimethyl ether, methyl ether, etc.), and the resulting solution can be applied (e.g., poured, dropped, coated, etc.) onto the substrate and subsequently dried. In some embodiments, the substrate 434 can contain and/or be formed of carbon (e.g., CNF). Application 436 of a rapid thermal shock (e.g., the pulse heating profile 330 of FIG. 3B; 1000-2000 K; 10 ms to 1 s pulse duration) to the assembly 430 can convert the metal salt precursors 432 into MEO nanoparticles 440 (e.g., high entropy oxide nanoparticles), with the high temperature driving precursor decomposition, formation of oxide, and further mixing toward high entropy uniform mixing.

To convert the oxide into carbide, the assembly 438 is subjected to a coating process 442, whereby a polymer layer 446 is provided on the MEO nanoparticles 440 to act as a carbon source. For example, a polymer (e.g., PVA, PVP, PVDF, PTFE, etc.) can be dissolved into alcohol and can be applied (e.g., poured, dropped, coated, etc.) onto the substrate and subsequently dried to form the polymer layer 446. Application 448 of extended heating (e.g., carbonization anneal of FIG. 4C or the shockwave heating of FIG. 4D) to the assembly 444 drives the carbide formation reaction from the MEO, thereby converting the MEO nanoparticles 440 into uniform ME-carbide nanoparticles 452 on substrate 434 (e.g., thereby forming structure 450). During the high temperature transformation process, the MEO nanoparticles 440 were physically confined by the coated polymer 446 and thus maintained their size and distribution. The polymer coating 446 not only supplied the carbon source but also limited the undesirable aggregation or ripening of the nanoparticles 440 during carbonization. In some embodiments, the substrate 434 (e.g., CNF) can also serve as another carbon source to ensure the complete transformation, by which the ME-carbide nanoparticles 452 become firmly anchored onto the etched substrate surface.

The formation of ME-carbide is a solid phase reaction (e.g., MEO+C converts to ME-carbide) and thus may require additional time for diffusion and phase transition. Accordingly, the application 448 of heating, whether via annealing or shockwave profiles, is provided over a relatively longer time period (e.g., on the order of tens of seconds, such as 1-2 minutes) to enable complete conversion from MEO 440 to ME-carbide 452. In some embodiments, continuous annealing may lead to aggregation of nanoparticles due to long range diffusion. Thus, in some embodiments, shockwave heating may be preferable since it yields only short-range diffusion and therefore may be more controllable with respect to reaction time and particle size.

In some embodiments, the contribution from ME-carbide nanoparticle structure design and synthesis to its overall stability can be three-fold. First, the bond strength can increase following a fabrication sequence from metal-metal (M-M), to metal-oxygen (M-O) (e.g., in MEO nanoparticle 440), to metal-carbon (M-C) (e.g., in ME-carbide nanoparticle 452). The carbide structure may therefore allow for desirable intrinsic chemical stability when used as an electrocatalyst in harsh operating conditions. Second, the uniform mixing and high-entropy stabilization effect can further improve chemical and structural stability against parasitic reactions during electrocatalysis. Thermodynamically, increasing the reaction temperature (T) and entropy (ΔS) of the system can lead to the decrease of the Gibbs free energy (ΔG), suggesting that high temperature and high entropy are both favorable for forming ME-carbide nanoparticles. Third, owing to the etching mechanism during ME-carbide formation, these nanoparticles can become firmly embedded within and/or on the CNF substrate (rather than being loosely attached), thereby improving the stability of the structure and avoiding nanoparticle detachment. Taken together, the embedded ME-carbide nanoparticles can combine the advantages of covalent bonding, high-entropy stabilization, and surface structure toward ultra-high stability.

### Methods for Fabrication of MEI Nanoparticles

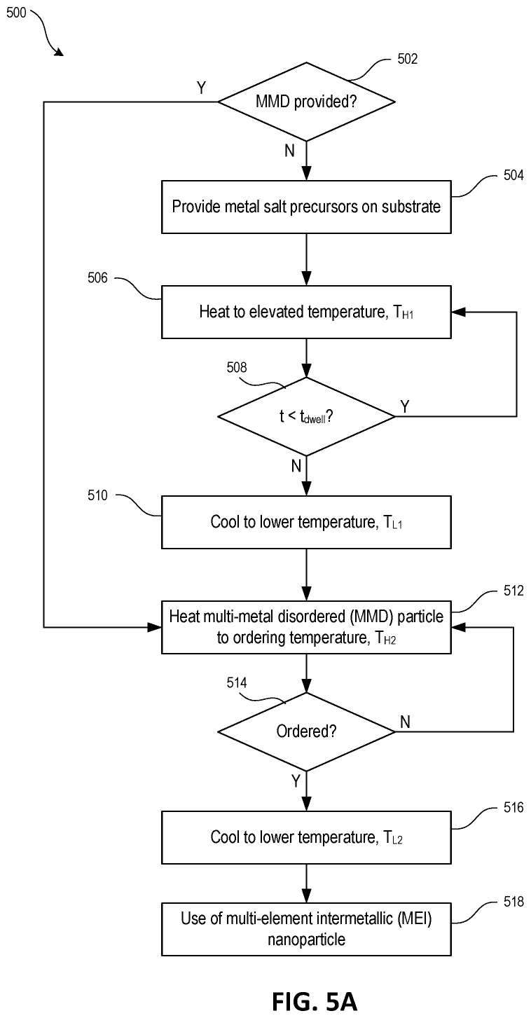

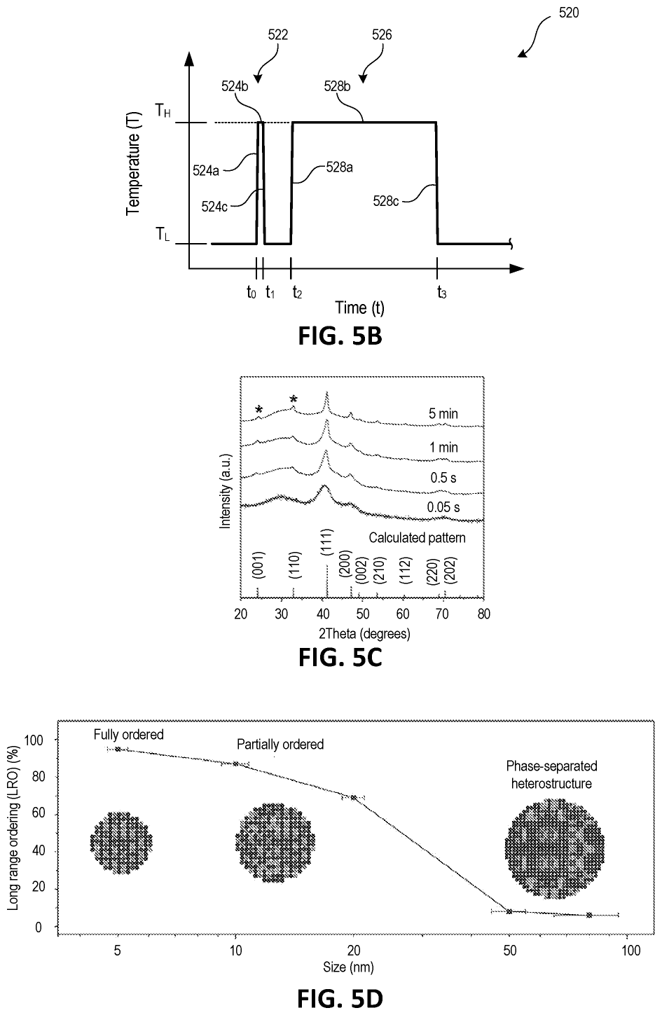

FIG. 5A shows an exemplary method 500 for forming MEI nanoparticles, such as MEI nanoparticle 210 of FIG. 2B and/or structure 230 incorporating MEI nanoparticles of FIG. 2G. The method 500 can initiate at decision block 502, where it is determined if multi-element starting nanoparticles (e.g., a high entropy alloy (HEA) or a multi-metal disordered (MMD)) are provided. If the starting nanoparticles have been provided, the method 500 can proceed to process block 512; otherwise, the method 500 can proceed to process block 504 to begin fabrication of the starting nanoparticles.

At process block 504, where multiple metal precursors for the desired MEI nanoparticle are loaded onto a substrate. As noted above, each MEI nanoparticle can be formed of at least three different metal elements (e.g., at least five different metal elements for high entropy configurations). Thus, in some embodiments, the precursors can include metal salts (e.g., metal chloride salt) in solution (e.g., ethanol, water, or a mixture thereof). In some embodiments, the loading can be provided by dip coating the substrate in one or more solutions containing the selected precursors, and then drying (e.g., at room temperature). Alternatively or additionally, the loading can be via any other application technique, such as, but not limited to, pouring, brushing, spraying, printing, or rolling the solution onto the substrate. The loading of precursors can mirror the desired composition for the mixture of the resulting of the nanoparticles, for example, such that a desired atomic ratio of metals is attained.

The method 500 can proceed to process block 506, where the substrate with precursors thereon is heated to a first elevated temperature, T_{H1}. The method 500 can proceed to decision block 508, where it is determined if the substrate has been maintained at the first elevated temperature for a predetermined pulse period or dwell time, t_{dwell}. If the predetermined dwell time has not been met, the method 500 can return to process block 506 where the heating is continued to maintain the substrate at the first elevated temperature. Otherwise, once the predetermined dwell time has been met, the method 500 can proceed from decision block 508 to process block 510, where the substrate is rapidly cooled to a first relatively low temperature, T_{L1}, thereby forming a plurality of the MMD nanoparticles (e.g., HEA nanoparticles) on the substrate.

The method 500 can proceed to process block 512, where the substrate with MMD nanoparticles thereon is heated to a second elevated temperature, T_{H2}, which may be the same or different (e.g., higher or lower) than the first elevated temperature. The method 500 can proceed to decision block 514, where it is determined if the substrate has been maintained at the second elevated temperature for a predetermined period to cause long-range ordering (e.g., LRO≥90%) of the metal atoms within the nanoparticles. If the predetermined ordering period has not been met, the method 500 can return to process block 512, where the heating is continued to maintain the substrate at the second elevated temperature. Otherwise, once the predetermined ordering period has been met, the method 500 can proceed from decision block 514 to process block 516, where the substrate is rapidly cooled to a second relatively low temperature, T_{L2}, (e.g., the same, higher, or lower than T_{L1}) thereby forming a plurality of MEI nanoparticles on the substrate. In some embodiments, blocks 504-516 of method 500 can subject the substrate to a two-stage heating process. The two-stage heating process can be achieved, for example, by the heating profile 520, as shown in FIG. 5B. In some embodiments, in a first stage 522, the heating profile 520 can comprise a rapid heating pulse, for example, similar in shape and/or timing to that employed to fabricate MEO nanoparticles (e.g. as shown in FIG. 3B) and/or to fabricate ME-carbide nanoparticles (e.g., as shown by individual pulse 472 in FIG. 4D). For example, the heating of the first stage 522 can initiate at a relatively low temperature, TL (e.g., <500 K, such as room temperature (e.g., 290-300 K)) and can include (i) a rapid heating ramp 524a (e.g., ≥10⁴ K/s), (ii) a short dwell period 524b (e.g., 10-100 ms, inclusive, such as about 50-55 ms) at or about a first elevated temperature, TH (e.g., >1000 K, such as about 1100 K), and (iii) a rapid cooling ramp 524c (e.g., ≥10⁴ K/s).

After the first stage 522, a second stage heating 526 can be performed, for example, at a delay after completion of the cooling ramp 524c (e.g., (t₂−t₁)≥100 ms, such as 1 second). In some embodiments, in the second stage 526, the heating profile 520 can comprise a prolonged heating, for example, similar in shape and/or timing to that employed to fabricate ME-carbide nanoparticles (e.g., as shown by profile 460 in FIG. 4C). For example, the heating of the second stage 526 can initiate at a relatively low temperature, T_{L} (e.g., <500 K, such as room temperature (e.g., 290-300 K)) and can include (i) a rapid heating ramp 528a (e.g., ≥10⁴ K/s), (ii) a prolonged dwell period 528b (e.g., 1-10 minutes, inclusive, such as about 5 minutes) at or about a second elevated temperature, TH (e.g., >1000 K, such as about 1100 K), and (iii) a rapid cooling ramp 528c (e.g., ≥10⁴ K/s).

Returning to FIG. 5A, in either of process blocks 506 or 512, the respective heating profile can be provided by passing electrical current through the substrate to provide Joule heating. Alternatively or additionally, in some embodiments, the heating profile can be provided by a separate heating mechanism (e.g., direct Joule heating, conduction heating, radiative heating, microwave heating, laser heating, plasma heating, or any combination of the foregoing) in thermal communication with the substrate and capable of providing the heating profile of FIG. 5B. The method 500 can proceed from process block 516 to process block 518, where the resulting MEI nanoparticles can be used in a particular application. For example, in some embodiments, the MEI nanoparticles (with or without the substrate used for fabrication) can be used as a catalyst for thermochemical reactions and/or electrochemical reactions.

Although some of blocks 502-518 of method 500 have been described as being performed once, in some embodiments, multiple repetitions of a particular process block may be employed before proceeding to the next decision block or process block. In addition, although blocks 502-518 of method 500 have been separately illustrated and described, in some embodiments, process blocks may be combined and performed together (simultaneously or sequentially). Moreover, although FIG. 5A illustrates a particular order for blocks 502-518, embodiments of the disclosed subject matter are not limited thereto. Indeed, in certain embodiments, the blocks may occur in a different order than illustrated or simultaneously with other blocks.

Embodiments of the disclosed subject matter can provide MEI nanoparticles having multiple elements, for example, by employing controllable synthesis of ordered intermetallics driven by low enthalpy. In some embodiments, the fabrication can rely on a multi-elemental disorder-to-order phase transition strategy (e.g., HEA to MEI) that yields a more thermodynamically stable configuration. The disclosed techniques can be used to synthesize MEI nanoparticles, for example, having a size of about 4-5 nm and/or as many as eight different metal elements, without the particle growth and/or phase separation commonly encountered in conventional intermetallic fabrication techniques. To investigate the disorder-to-order phase transition that enables MEI formation, an array of quinary Pt(Fe_{0.7}Co_{0.1}Ni_{0.1}Cu_{0.1}) samples were synthesized by heating at ˜1100 K for different amounts of time, and their degree of ordering characterized via XRD, as shown in FIG. 5C. According to a calculated virtual XRD pattern, the diffraction peaks of (001) at 24.2° and (110) at 33.4° are the superlattice peaks of the ideal L1₀ intermetallic structure of Pt(Fe_{0.7}Co_{0.1}Ni_{0.1}Cu_{0.1}). Based on the intensities of these peaks, the ordering degree of the different quinary samples was quantified using the LRO parameter (see equation (2) above).

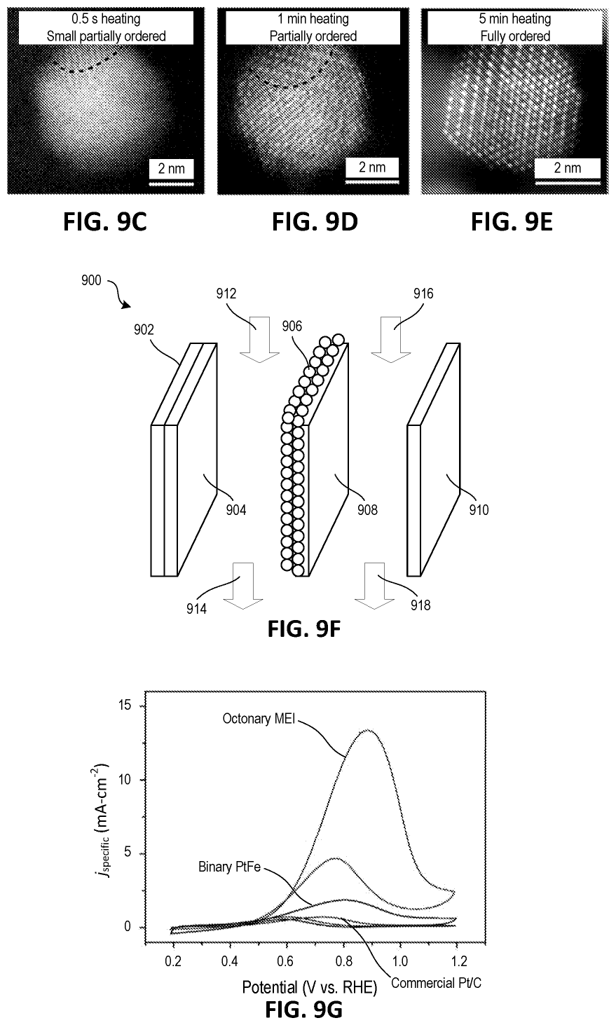

Superlattice diffraction peaks were not observed for the sample made with only 0.05 s of heating, suggesting that the short heating time is incapable of inducing the disorder-to-order phase transition for Pt₁Fe_{0.7}Co_{0.1}Ni_{0.1}Cu_{0.1}. As the heating time was increased from 0.5 s to 5 min, the characteristic diffraction peaks of L1₀, (001) and (110), gradually intensified, as shown in FIG. 5C. As a result, the LRO increased from 10% (0.5 s) to 60% (1 min) and finally ˜100% (5 min) (see FIG. 9A), demonstrating the disorder-to-order phase transition process that completes after 5 min of heating. The effect of the heating temperature and time on the LRO of the quinary Pt(Fe_{0.7}Co_{0.1}Ni_{0.1}Cu_{0.1}) demonstrated ˜100% LRO could only be achieved by heating at ˜1100 K for −5 min. This disorder-to-order transition process (0.5 s to 5 min) is also consistent with the scanning transmission electron microscopy (STEM) imaging (FIGS. 9C-9E) of the quinary Pt(Fe_{0.7}Co_{0.1}Ni_{0.1}Cu_{0.1}) MEI nanoparticles synthesized at ˜1100 K for different heating durations. For example, FIGS. 9C-9E show that the disordered HEA nanoparticle structure converts to an MEI structure over the course of −5 min heating.

This disorder-to-order phase transition toward single-phase MEIs of immiscible elements may only be achieved at the nanoscale. For quinary Pt(Fe_{0.7}Co_{0.1}Ni_{0.1}Cu_{0.1}) nanoparticles, the fully ordered L1₀ structure (LRO=100%) can be obtained for particles having a diameter of 4-5 nm. However, as shown in FIG. 5D, the LRO decreases with the particle size for particles larger than 5 nm, irrespective of the particle synthesis method (e.g., slow cooling or longer heating time). When the particle size increases to −60 nm or larger, the particle shows disordered or other phase-separated heterostructures, as confirmed by STEM and energy dispersive X-ray analysis (EDX).

### Systems for Nanoparticle Fabrication

In some embodiments, a system for MEC nanoparticle fabrication can include a heating mechanism and a controller operatively coupled to and configured to control the heating mechanism, for example, to achieve any of the heating profiles disclosed herein. For example, the heating mechanism can comprise a direct Joule heater, a conduction heater, a radiative heater, a microwave heater, a laser, a plasma, or any combination of the foregoing, or any other means for semi-continuous or pulsed heating. In some embodiments, the substrate upon which the MEC nanoparticles are provided and/or coupled can be part of the heating mechanism (e.g., by flowing a current through the substrate to provide Joule heating).

In some embodiments, the fabrication system can optionally include a rapid cooling mechanism. For example, the rapid cooling mechanism can comprise passive cooling by radiation, conduction, or both; active cooling by conduction, convection, or both; active cooling by phase or chemical transitions induced by heat absorption; any other means for rapid cooling (e.g., at least 10⁴ K/s); or any combination of the foregoing. In some embodiments, the controller can be operatively coupled to and configured to control the rapid cooling mechanism as well, for example, to achieve any of the heating profiles disclosed herein.

Components of the nanoparticle fabrication system and/of configurations thereof can be similar to the heating systems described in U.S. Pat. No. 11,193,191, published Dec. 7, 2021, U.S. Publication No. 2018/0369771, published Dec. 27, 2019, International Publication No. WO 2020/252435, published Dec. 17, 2020, and/or International Publication No. WO 2020/236767, published Nov. 26, 2020, all of which are incorporated by reference herein.

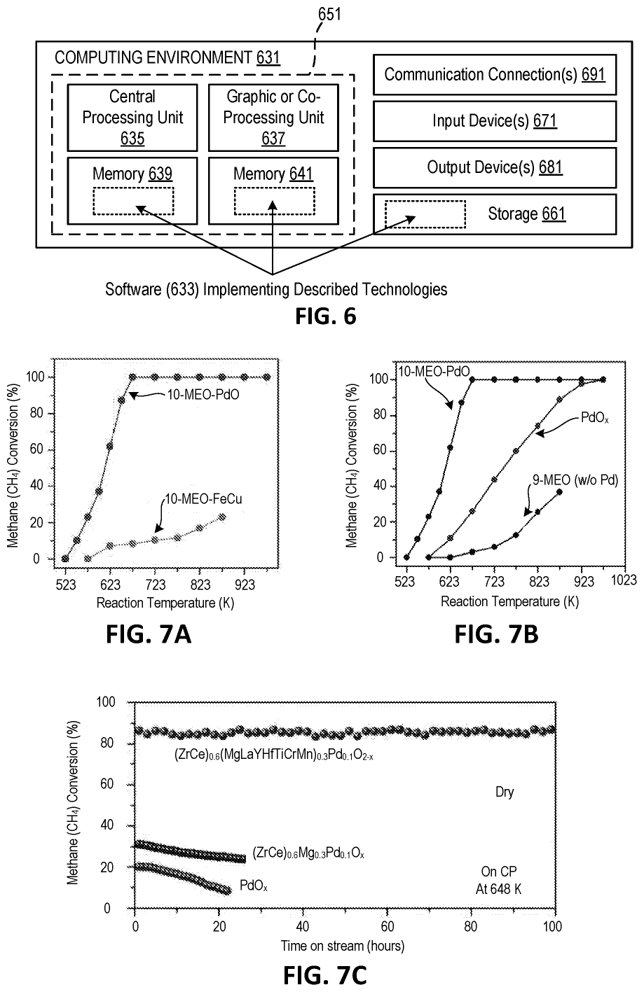

FIG. 6 depicts a generalized example of a suitable computing environment 631 in which the described innovations may be implemented, such as aspects of the nanoparticle fabrication system described above, method 300, method 400, and/or method 500. The computing environment 631 is not intended to suggest any limitation as to scope of use or functionality, as the innovations may be implemented in diverse general-purpose or special-purpose computing systems. For example, the computing environment 631 can be any of a variety of computing devices (e.g., desktop computer, laptop computer, server computer, tablet computer, etc.).

With reference to FIG. 6, the computing environment 631 includes one or more processing units 635, 637 and memory 639, 641. In FIG. 6F, this basic configuration 651 is included within a dashed line. The processing units 635, 637 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 6 shows a central processing unit 635 as well as a graphics processing unit or co-processing unit 637. The tangible memory 639, 641 may be volatile memory (e.g., registers, cache, RAM), non-volatile memory (e.g., ROM, EEPROM, flash memory, etc.), or some combination of the two, accessible by the processing unit(s). The memory 639, 641 stores software 633 implementing one or more innovations described herein, in the form of computer-executable instructions suitable for execution by the processing unit(s).

A computing system may have additional features. For example, the computing environment 631 includes storage 661, one or more input devices 671, one or more output devices 681, and one or more communication connections 691. An interconnection mechanism (not shown) such as a bus, controller, or network interconnects the components of the computing environment 631. Typically, operating system software (not shown) provides an operating environment for other software executing in the computing environment 631, and coordinates activities of the components of the computing environment 631.

The tangible storage 661 may be removable or non-removable, and includes magnetic disks, magnetic tapes or cassettes, CD-ROMs, DVDs, or any other medium which can be used to store information in a non-transitory way, and which can be accessed within the computing environment 631. The storage 661 can store instructions for the software 633 implementing one or more innovations described herein.

The input device(s) 671 may be a touch input device such as a keyboard, mouse, pen, or trackball, a voice input device, a scanning device, or another device that provides input to the computing environment 631. The output device(s) 671 may be a display, printer, speaker, CD-writer, or another device that provides output from computing environment 631.

The communication connection(s) 691 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Fabricated Examples and Experimental Results

### MEO Nanoparticles

Denary oxide (Zr,Ce,Hf,Ti,La,Y,Gd,Ca,Mg,Mn)O₂₋ₓ(denoted as 10-MEO-MgMn, where x represents oxygen vacancy) nanoparticles were synthesized according to the disclosed fabrication techniques. In particular, conductive carbon nanofibers (CNFs) was chosen as the substrate and was utilized for joule heating to provide rapid high-temperature heating with controllable magnitude and duration. A solution of polyacrylonitrile with a concentration of 8 wt. % in dimethylformamide was electrospun into polyacrylonitrile fibers at a voltage of 13 kV and a spinning distance of 15 cm. These as-spun films were first stabilized at 553 K for 6 hours in air and then carbonized at 1273 K for 2 hour in argon to prepare the CNFs as the substrate. Multiple salt precursors of each element were mixed in the solution phase (0.05 mol/L) in equal molar amounts, and the mixed precursor salt was uniformly coated onto the CNF substrate with a loading of 100 μL/cm². For example, CeN₃O₉·6H₂O (99.0%), LaN₃O₉·6H₂O (99.99%), YN₃O₉·6H₂O (99.9%), CaN₂O₆·4H₂O (99.0%), MgN₂O₆·6H₂O (99.0%), GdN₃O₉·6H₂O (99.9%), MnN₂O₆·4H₂O (97.0%), FeN₃O₉·9H₂O (98.0%), CoN₂O₆·6H₂O (98.0%), CuN₂O₆·6H₂O (98.0%), NiN₂O₆·6H₂O (98.0%), InN₃O₉·xH₂O (99.9%), CrN₃O₉·9H₂O (99.0%), ZnN₂O₆·6H₂O (98.0%), PdCl₂ (99.0%), HfCl₄ (99.9%), ZrCl₄ (99.9%), TiCl₄ (99.9%), VCl₃ (97.0%), and NbCl₅ (99.9%) were dissolved in ethanol/water mixtures with a volume ratio of 9/1 to prepare the different salt solutions (0.05 mol/L). Different salts were chosen and mixed at equimolar amounts in the multi-element synthesis. These solutions were loaded onto the CNF films with a loading of 100 mL/cm², and then dried at room temperature prior to high-temperature heating.

High-temperature synthesis by electrical Joule heating was carried out in an argon atmosphere (P_{O2}: −1 ppm) or controlled oxygen partial pressure (high P_{O2}: in air). The CNF or carbon paper film was cut to sizes of 5 mm×20 mm, which were adhered to copper electrodes supported by glass slides using silver paste and then connected with a current supply. Different input currents were applied to the material and the resulting high temperature produced an emitted light, which was recorded using a high-speed camera to determine the sample temperature. After high-temperature heating (e.g., 1500 K for 50 ms), scanning electron microscopy (SEM) imaging revealed the formation of homogenous and high-density nanoparticles on the CNFs. Particle size and distribution can be further tailored by adjusting the duration of the synthesis, for example, where shorter heating times yield smaller particle sizes (e.g., 8 nm for a 10 ms heating pulse) with a narrower size distribution, and longer heating times yield larger particle sizes (e.g., 40 nm for a 500 ms heating pulse) with a larger size distribution.

Scanning transmission electron microscopy (STEM) elemental mapping of the 10-MEO-MgMn nanoparticles revealed homogeneous mixing of the 10 different elements throughout the fabricated nanoparticles without obvious elemental segregation or phase separation. Note that the 10 cationic elements and their respective unary oxides have very different physicochemical properties, including a range of cation radii (0.74-1.16 Å) and crystal structures (e.g., fluorite, rutile, and rock-salt), which would otherwise prevent single-phase homogeneous mixing in conventional fabrication techniques. In contrast, the disclosed techniques use high temperature to promote multi-element mixing for MEO nanoparticle formation while ensuring that the heating duration is short enough to prevent particle coarsening and phase separation. Accordingly, with this unique fast heating technique and the above discussed three MEO synthesis strategies, a library of oxide nanoparticles with tunable compositions (from unary up to denary mixing) have been achieved that are neither observed nor necessarily stable in bulk materials.

Density functional theory (DFT) calculations were performed to assess each thermodynamic parameter in the formation of a series of oxide systems. For example, the formation temperature of binary (Zr,Ti)O₂ from the corresponding unary oxide was predicted to be 2828 K, whereas the quaternary (Zr,Ce,Hf,Ti)O₂ could form a single-phase structure at a temperature of just 1075 K. This result indicates that a high temperature is necessary for single-phase MEO formation (temperature-driven mixing) while a lower formation temperature for a high entropy system with increased number of components indicates the entropy-driven mixing effect. The calculated Gibbs free energy of (Zr,Ce,Hf,Ti)O₂ decreases with increasing P_{O2}, revealing the material's oxidation-driven stabilization. In addition, the DFT calculation results predict reasonable structural and chemical stability by considering lattice distortion and various decomposition pathways for the formed single-phase MEOs. Hence, the DFT results confirm that temperature, oxidation, and entropy play an important role in driving the formation of single phase MEOs.

Kinetically, although high temperature is critical to overcome the kinetic barriers for multi-element mixing, too high of a temperature can adversely induce particle deterioration, such as coarsening, aggregation, and phase separation (e.g., metallic impurities). Experimentally, for (Zr,Ce,Hf,Ti,Mn,Co)O₂₋ₓ, at a low synthesis temperature of ˜1200 K, the formation of uniform nanoparticles was not observed on the CNF substrate. Rather, terrace-shaped oxides were present due to insufficient reaction. On the other hand, an increase of the synthesis temperature to 1800 K accelerates the particle growth and aggregation (>80 nm) and introduces metal impurities (e.g., Co) due to the carbothermal reduction. Therefore, an optimized temperature (˜1500 K) may be used to synthesize uniform MEO nanoparticles on CNFs, for example, by providing just enough energy to mix all the elements while preventing the as-formed oxides from agglomerating and reacting with carbon.

Due to the high-temperature synthesis and entropy stabilization, the EO nanoparticles naturally possess excellent thermal stability. Experimentally, the structural stability of MEOs was observed by heating ternary oxide (Ce,Gd,Y)O₂₋ₓ, quaternary oxide (Zr,Ce,Hf,Ti)O₂, and denary oxide 10-MEO-MgMn nanoparticles from 298 K up to 1073 K by in situ STEM (the samples were stabilized at each temperature for 1 hour before taking images). At 1073 K, the 10-MEO-MgMn nanoparticles exhibit superior morphology and size stability, and maintain uniform mixing without phase separation. In contrast, changes in the morphology and size for the ternary sample and elemental separation for both the ternary and quaternary oxides were observed. These experimental results on the thermal stability of the MEOs are consistent with the force field simulations and reveal the superior thermal stability of our denary EO nanoparticles, which may be due to its high-entropy structure featuring both thermodynamic and kinetic stability.

The disclosed high-throughput synthesis method can enable the rationale design and rapid exploration of a large library of MEO nanoparticles, for example, by mixing most elements in the periodic table. Such MEO nanoparticles can be particularly advantageous for catalytic applications, for example, for methane combustion. Compared to conventional flame combustion, the catalytic combustion of methane is capable of stabilizing complete oxidation of fuel at low temperature, while simultaneously reducing emissions (e.g., minimal NOx emission). However, the PdOₓ catalysts typically used for such reactions suffer from deactivation due to sintering of the nanoparticles and the transformation of PdOₓ into metallic Pd during the reaction. Therefore, developing Pd-based catalysts with enhanced performance and stability can effectively improve the energy efficiency of the catalytic CH₄ combustion process.

When formulating the MEO catalysts, elements from different groups can be included, such as alkali metals, 3d-5d transition metals, and the noble metal Pd, which provide distinct catalytic functions, for example, promoting the transfer of electrons during the redox process, improving the redox capability and creating more oxygen defects, and activating CH₄, respectively. MEO catalysts were prepared using the disclosed high-temperature synthesis method with an oxide loading of −2 wt. % in each catalyst. Single-element PdOₓ nanoparticles were also synthesized with similar Pd loadings and served as a control in this study. In the first step, 4-MEO (X,Y)_{0.6}Mg_{0.3}Pd_{0.1}Oₓ(where X and Y represent different metal elements) nanoparticles supported on carbon paper were screened as catalysts for CH₄ combustion and compared to the PdOₓ control sample. The catalytic activity was systematically measured at 573-973 K using a plug flow reactor with a gas hourly space velocity (GHSV) of 10,800 L/(g_{Pd} h) and 5 vol % CH4 and 20 vol % O₂ for the feeding gas, balanced by N₂. It was confirmed that the bare carbon paper substrate did not degrade in air at temperatures below 973 K by thermogravimetric analysis (TGA) measurement and additionally was inactive for CH₄ combustion. For all the 4-MEO catalysts, the reaction had an onset temperature of ˜623 K, and the CH₄ conversion increased with the reaction temperature. Among screened 4-MEO catalysts, (Zr,Ce)_{0.6}Mg_{0.3}Pd_{0.1}Oₓ showed the best performance (100% conversion at ˜823 K), which is much more active than the control PdOₓ (74% conversion at 823 K).

In the second step, after screening among the 4-MEOs (e.g., (Zr,Ce)_{0.6}Mg_{0.3}Pd_{0.1}Oₓ), eight different elements out of the 3d-5d transition metals were added to the (Zr,Ce)_{0.6}Mg_{0.3}Pd_{0.1}Oₓ to construct a series of 5-MEOs with the composition of (Zr,Ce)_{0.6}(Z)_{0.15}Mg_{0.15}Pd_{0.1}Oₓ, in which Z=La, Y, Hf, Ti, Cr, Mn, Fe, and Cu. The catalytic activities of the 5-MEO samples were measured at 623 K and compared with the 4-MEO (Zr,Ce)_{0.6}Mg_{0.3}Pd_{0.1}Oₓ. When Z=La, Y, Hf, Ti, Cr, Mn, these 5-MEOs outperformed (Zr,Ce)_{0.6}Mg_{0.3}Pd_{0.1}Oₓ, while the poison effect was observed with the addition of Fe and Cu. Finally, by combining six elements screened out from the second step (e.g., La, Y, Hf, Ti, Cr, and Mn) with the best performing (Zr,Ce)_{0.6}Mg_{0.3}Pd_{0.1}Oₓ (4-MEO-Pd), a denary oxide (Zr,Ce)_{0.6}(Mg,La,Y,Hf,Ti,Cr,Mn)_{0.3}Pd_{0.1}O₂₋ₓ (10-MEO-PdO) was synthesized with the highest entropy among these MEO catalysts.

Catalytic methane combustion was conducted in a fixed-bed flow reactor at atmospheric pressure. Denary oxide nanoparticles were formed on the carbon paper or Al₂O₃-coated carbon paper with a loading of −2 wt. % using the disclosed high-temperature strategies. The carbon paper used was first activated at 1173 K for 180 min in a carbon dioxide atmosphere. It was further confirmed that the carbon paper and Al₂O₃ coated carbon paper were stable up to 973 K. For the control PdOₓ sample, the impregnation method (e.g., the precursors were first loaded onto the carbon paper, and then the sample was thermally-treated (3 K/min, 773 K, 120 min) in a furnace with air atmosphere) to prepare particles with the same Pd loading. For example, 50 mg of catalyst (e.g., carbon paper with oxide loading of 2 wt. %) was loaded into a microflow quartz reactor (7 mm inner diameter). The catalyst bed was placed between quartz wool plugs in the reactor. The catalyst was heated to 473 K, 523 K, or 573 K at a rate of 5 K/min under N₂ (20 mL/min), and the gas flow was then switched to the reactant feeds (18 mL/min, space velocity=10,800 L (g_{pd} h)⁻¹ or 180 mL/min, space velocity=108,000 L (g_{pd} h)⁻¹). The reactants, CH₄ (99.99%) and O₂ (99.999%), with N₂ as the balance, were co-fed into the reactor using calibrated mass flow controllers with a CH₄:O₂ molar ratio of 1:4.

For testing the catalytic performance in the presence of water, ˜4 vol % H₂O was added to the gas feed using a steam generator maintained at 303 K. The reaction temperature was increased stepwise from 473 K, 523 K, or 573 K to 973 K, and the reaction was carried out at each temperature until the conversion reached constant. To determine the conversions of the reactants and the formation of products, a gas chromatograph was employed, equipped with a silica capillary column and a barrier ionization discharge (BID) detector. All of the lines between the reactor outlet and GC sampling loop inlet were heat-traced to 423 K to prevent product condensation. Methane conversion was calculated as follows:

$${CH}_{4} conversion ( \% ) = \frac{{[ {CH}_{4} ]}_{inlet} - {[ {CH}_{4} ]}_{o u t l e t}}{{[ {CH}_{4} ]}_{inlet}} \times 100 \qquad ( 3 )$$

The 10-MEO-PdO exhibited high catalytic activity compared to other catalysts (single PdOₓ, 4-MEOs, and 5-MEOs), reaching a complete conversion at 673 K, as shown in FIG. 7A. A control 9-MEO (Zr,Ce)_{0.66}(Mg,La,Y,Hf,Ti,Cr,Mn)_{0.34}O₂₋ₓ sample (without Pd) was much less active for CH₄ combustion (e.g., as shown in FIG. 7B), indicating the importance of stabilizing Pd in the 10-MEO-PdO sample for improved catalytic performance.

The catalytic stability of PdOₓ, the best performing 4-MEO-Pd, and the 10-MEO-PdO were also evaluated and compared continuously at 648 K (after the catalytic reaction at 973 K), as shown in FIG. 7C. The high catalytic activity of the 10-MEO-PdO catalyst was extremely stable, with no discernible drop after 100 hours, while the CH₄ conversion of the 4-MEO-Pd decreased from 31% to 20% after 26 hours. In contrast, the CH₄ conversion of the PdOₓ control dropped even faster, leading to deactivation after 22 hours, which may be due to the reduction of PdOₓ to metallic Pd during operation at high temperature, as subsequently confirmed by XRD after the extended stability test. The durability trend further confirms the advantages of the entropy effect ((Zr,Ce)_{0.6}(Mg,La,Y,Hf,Ti,Cr,Mn)_{0.3}Pd_{0.1}O₂₋ₓ>(Zr,Ce)_{0.6}Mg_{0.3}Pd_{0.1}Oₓ>PdOₓ), which can stabilize Pd in a cationic state in the high entropy structure for substantially improved overall catalyst stability. The denary oxide 10-MEO-PdO catalyst was also characterized after the 100 hour durability test by elemental mapping, observing nearly no change in the structural homogeneity.

To further stress the catalysts under harsh and practical applications, the 10-MEO-PdO catalyst was evaluated for methane combustion in the presence of water (˜4 vol %). The carbon paper substrate was protected by a thin layer of Al₂O₃ coating (deposited using atomic layer deposition) to avoid accelerated carbon etching under wet conditions. The 10-MEO-PdO catalyst demonstrated a high activity of complete CH₄ conversion at ˜673 K despite these harsh conditions. In particular, the higher GHSV of 108,000 L (g_{pd} h)⁻¹ ensures the stability evaluation was performed under the kinetically controlled regime. Notably, the 10-MEO-PdO sample showed stable performance in both cases for 100 hour continuous operation, demonstrating the intrinsic stability of the catalyst.

### ME-Carbide Nanoparticles

Mo₂C was initially selected as a model material to study the detailed mechanism during the two-step high temperature transformations. The CNF substrate was first prepared using an electrostatic spinning method, which was uniformly coated with metal salt precursors. Polyaniline (M_{w}>15,000) was dissolved into N,N-Dimethylformamide with 8 wt. %. Precursors of CNF were prepared by electrostatic spinning method (e.g., 15 kV) with appropriate thickness. CNF films were obtained by activization of the CNF precursor at 280° C. in air for 6 hours and subsequent carbonization process at 1000° C. in Ar for 2 hours. TiCl₄, ZrCl₄, VCl₄, NbCl₅ and MoCl₅ were dissolved into alcohol with the concentration of 0.05 M separately. Five equivalent solutions were mixed and poured onto the CNF substrate at an areal density of 100 μL/cm².

The loaded CNF substrate was then transferred to a Joule heating setup (e.g., thermal shock device). For example, after drying, a 1×0.5 cm CNF substrate with mixed precursor salts thereon was adhered between two copper tapes (fixed on the glass sheets) by using the silver paste. The resulting device was then transferred into the glovebox, and opposite ends of the copper tapes were connected by wires to a current source. MEO nanoparticles (e.g., MoO₂ intermediate nanoparticles) can be obtained after a 55 ms thermal shock process. Using a high-speed thermal sensing camera, the detected light spectrum emanating from the heating setup was used to determine the temperature profile (e.g., based on blackbody radiation). The Joule heating setup enabled rapid heating (e.g., ramp rate >10⁴K/s) and cooling (e.g., ramp rate >10⁵ K/s) rates, which ensured that ultra-small MoO₂ nanoparticles with a diameter of −20 nm were uniformly distributed on the CNF substrate. The X-ray diffraction pattern of these nanoparticles matched well with the MoO₂ phase, suggesting successful synthesis.

In a second step, the obtained MoO₂ nanoparticles on the CNF substrate were coated with a thin and uniform layer of polymer (e.g., 50 μL/cm² polyvinylpyrrolidone (PVP)/alcohol solution (0.05 g/mL)). A second high temperature treatment (e.g., carbonization) was then performed, which resulted in the final ME-carbide nanoparticles supported on the CNF substrate. By slowly increasing the electric current applied to the CNF substrate, the system temperature was gradually ramped to 2000 K and was maintained for one minute, followed by rapid quenching to room temperature by cutting off the electrical signal, thereby resulting in the ME-carbide nanoparticles on the CNF substrate.

A control experiment was carried out in parallel using conventional furnace heating in Ar atmosphere for the same MEO to ME-carbide transformation process. Due to furnace system limitations, the highest heating rate achieved was 20 K/minute, and the highest temperature was 1273 K. Therefore, the whole process was ˜4-5 orders of magnitude longer compared with the disclosed Joule heating method. Due to the long heating time and slow cooling rate by furnace heating, the ME-carbide particles were found to be severely aggregated. In contrast, all the ME-carbide nanoparticles formed using the disclosed Joule heating technique had a uniform size of 15 nm and were embedded firmly onto the CNF substrate. The uniform distribution of ME-carbide nanoparticles (e.g., Mo₂C) on the substrate was confirmed by Xray diffraction. In addition to Mo₂C, other unary metal carbide nanoparticles, such as TiC, ZrC, VC and NbC, were also prepared in the same manner with good material quality. A high-entropy carbide (HEC) nanoparticle (e.g., (TiZrVNbMo)Cₓ) was prepared in a similar fashion as the above-noted unary carbides, for example, by loading a mixture of metal salt precursors onto the CNF substrate, followed by the two-step Joule heating (e.g., FIGS. 3B and 4C or 4D).

Among the selected carbide components, Mo₂C exhibited good performance for hydrogen evolution reactions (HER) and oxygen evolution reaction (OER) processes as the catalytically active component, while the addition of TiC, ZrC, VC, and NbC can increase the entropy for enhanced stability. Upon carbonization, uniformly distributed HEC nanoparticles with diameters of −20 nm were formed on the CNF substrate, as confirmed by transmission electron microscopy (TEM). The TEM images also showed the HEC nanoparticles embedded within the CNF substrate due to the etching mechanism (e.g., where the CNF serves as a carbon source in addition to the polymer coating). X-Ray diffraction patterns of high entropy oxide (HEO) nanoparticles and HEC nanoparticles were collected and compared to confirm the phase transformation. Despite the short synthesis time (e.g., 55 ms), the obtained HEO nanoparticles were highly crystalline. After carbonization, (TiZrVNbMo)Oₓ nanoparticles were found to be completely transformed to (TiZrVNbMo)Cₓ nanoparticles.

After each Joule heating stage, the Mo 3d and Zr 3d spectra were collected by X-ray photoelectron spectroscopy (XPS). The peaks of 229.7, 232.9 and 235.9 eV of MoOₓ correspond to Mo₄₊, Mo₆₊/Mo₄₊ and Mo₆₊, respectively. In contrast, MoCₓ exhibits two distinct peaks at 228.8 and 231.9 eV, corresponding to Mo₂₊ and Mo₂₊/Mo₅₊ respectively, due to metal reduction by carbon. Similar results were obtained by XPS for Zr 3d, where the peak at 179.7 eV indicates the partial reduction of Zr₄₊ to Zr₂₊ during carbonization at the second Joule heating stage.

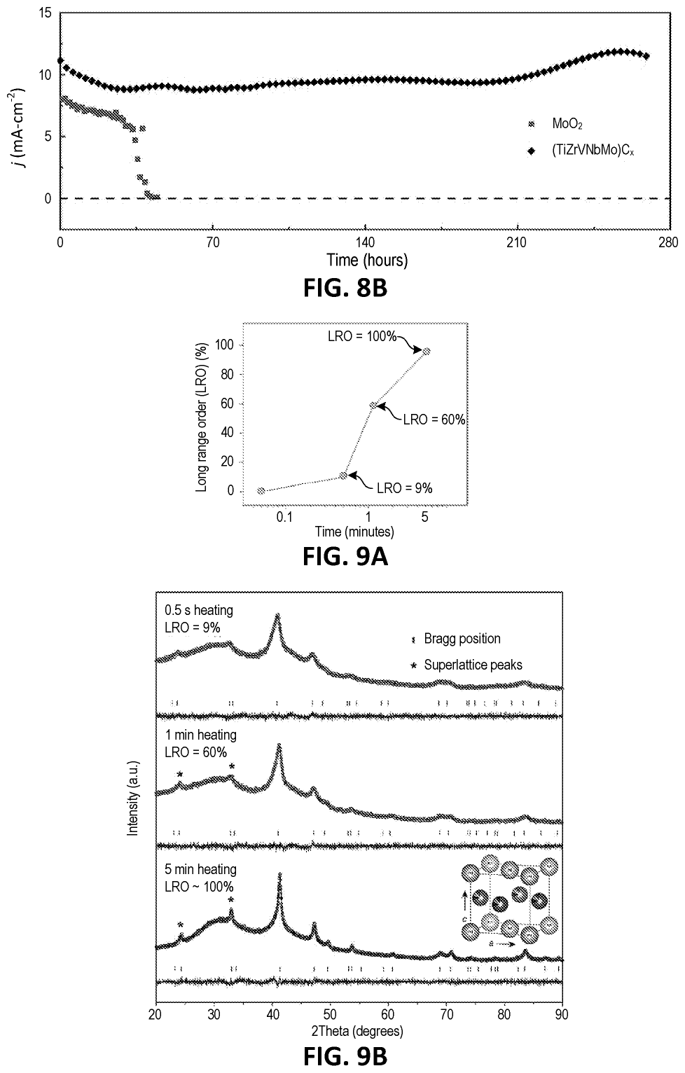

To evaluate the stability of the as-prepared HEC nanoparticles as an electrocatalyst, HER was employed as a model reaction. The electrochemical test was conducted in 0.5 M H₂SO₄ with a counter electrode of carbon rod and an Ag/AgCl reference electrode. The HEC nanoparticles anchored on the CNF substrate can be used directly as the work electrode. The linear sweep voltammetry (LSV) curve was conducted at a scan rate of 5 mV/s, from 0.1 V until a peak appeared, and the potential was corrected to the reversible hydrogen electrode (RHE) at room temperature. The stability was tested at constant potential (e.g., a current density of ˜10 mA/cm²). FIG. 8A shows results of MoO₂, Mo₂C, and (TiZrVNbMo)Oₓ nanoparticles supported on respective CNF substrates. Among the tested samples, (TiZrVNbMo)Cₓ exhibited the lowest overpotential of 140 mV at a current density of 10 mA/cm². The current density was also the highest for (TiZrVNbMo)Cₓ at an overpotential of 200 mV in comparison to its unary carbide, unary oxide and HEO counterparts.

To evaluate the stability of HEC nanoparticles, chronoamperometry was conducted with prolonged operation time, as shown in FIG. 8B. The current density for MoO₂ decayed rapidly to −0 mA/cm² within 10 hours, which is typical for oxides. In contrast, the (TiZrVNbMo)Cₓ nanoparticle remained stable for 250 hours at a current density of about 10 mA/cm². Such a superior stability can be attributed to the covalent bonding of carbide, the high entropy stabilization effect, and the substrate etching process during synthesis. TEM images for HEC after long term HER operation further confirmed the excellent structural stability. The nanoparticles on CNF substrate remain uniformly dispersed without observable aggregation or detachment even after 250 hours of operation.

### MEI Nanoparticles

To synthesize the MEI nanoparticles, a carbon substrate was loaded with desired metal salt precursor combinations/ratios and heated, with precise control of the temperature and heating/cooling rates by tuning the power applied to the substrate. In particular, the MEI nanoparticles were synthesized by Joule heating on a carbonized wood substrate. For example, basswood (e.g., 1.5 cm×0.5 cm×0.5 cm in size) was treated at 533 K in air for 6 h hours with a heating rate of 5 K/min and then maintained at 1273 K in argon flow for another 6 hours to carbonize. The resulting substrate was further activated at 1023 K in a CO₂ flow for 6 hours to introduce surface defects.

Metal salt precursors, such as H₂PtCl₆, PdCl₂, HAuCl₄, FeCl₃, CoCl₂, NiCl₂, CuCl₂, and SnCl₂, were provided in ethanol (0.05 mol/L). The precursor solutions (binary PtFe, quinary PtFe_{0.7}Co_{0.1}Ni_{0.1}Cu_{0.1}/Pt₁Fe_{0.25}Co_{0.25}Ni_{0.25}Cu_{0.25}, and octonary Pt_{0.8}Pd_{0.1}Au_{0.1}Fe_{0.6}Co_{0.1}Ni_{0.1}Cu_{0.1}Sn_{0.1}) were mixed at stoichiometric ratios and dispensed onto the carbon substrate using a micropipette at a loading of ˜800 μL/cm². Opposite ends of the carbon substrate were suspended on glass slides and connected to two copper electrodes with silver paste. The precursor-loaded carbon substrates were then dried in a 353 K oven for 6 hour and used directly for the Joule-heating method. For example, an adjustable current source was connected to the precursor-loaded carbon substrates within an Ar-filled glovebox. Electrical pulses with different duration times (0.05 s, 0.5 s, 1 min, and 5 min) were applied to the carbon substrate to generate the desired temperature and heating time (e.g., as shown in FIG. 5B) to synthesize the MEI nanoparticles.

First, solid-solution (HEA) nanoparticles were synthesized by heating the metal precursors for tens of milliseconds at ˜1100 K, for example, to mix the different elements without phase separation. A disorder-to-order phase transition is then achieved by rapidly re-heating the materials to ˜1100 K for an additional −5 mins—a limited amount of time that is sufficient to complete the desired transition from the disordered HEA structure to the ordered, single-phase MEI configuration while simultaneously avoiding nanoparticle growth and/or agglomeration. Finally, the single-phase MEI structure and small particle size (˜5 nm) is preserved by rapidly cooling the materials (˜10⁴ K/s).

To demonstrate the versatility of the proposed synthesis, binary, quinary, and octonary intermetallic nanoparticles were fabricated and characterized by scanning transmission electron microscopy (STEM), atomic resolution STEM, and energy-dispersive X-ray spectroscopy (EDX). The PtFe binary and Pt(Fe_{0.7}Co_{0.1}Ni_{0.1}Cu_{0.1}) quinary intermetallic nanoparticles demonstrate small particle sizes and narrow size distributions of 5.4±0.8 nm and 4.4±0.5 nm, respectively. A high-angle annular dark-field STEM (HAADF-STEM) image of a binary PtFe nanoparticle shows alternating layers of Fe and Pt columns, which is typical of an L1₀ intermetallic structure. The ordered L1₀ structure of the binary PtFe sample was further confirmed from the interplanar spacings of 3.71, 2.73, and 2.20 Å in the STEM images, which correspond to the (001), (110), and (111) facets of the ordered L1₀ structure along the [1-10] direction, respectively.

Similarly, the quinary Pt(Fe_{0.7}Co_{0.1}Ni_{0.1}Cu_{0.1}) nanoparticles showed alternating darker columns of Fe, Co, Ni, and Cu atoms and brighter columns of Pt atoms. Atomic resolution EDX mapping indicates that the well-defined Pt atoms are in one sub-lattice while the Fe, Co, Ni, and Cu atoms are uniformly distributed in the other sub-lattice, both with the L1₀ structure. According to the fitted extended X-ray absorption fine structure (EXAFS), the coordination number of Fe—Pt (6) is much larger than that of Fe—Cu (1.2), Cu—Fe (1.0), Co—Ni (2.0), and Ni—Co (2). These results are in accordance with the L1₀ structure in which the Fe—Cu, Cu—Fe, Co—Ni, and Ni—Co bonds in the quinary intermetallic are localized and limited to two-dimensional layer bonding in the ordered structure, while the Fe—Pt bonding occurs in a three-dimensional structure in the intermetallic.

Quinary MEI nanoparticles were also synthesized with different elemental ratios as well as different intermetallic structure (e.g., the L1₂ phase of (Pt_{0.8}Au_{0.1}Pd_{0.1})₃(Fe_{0.9}Co_{0.1})), showcasing the potential of this rapid/limited heating method to broaden the scope of possible intermetallic materials. Finally, octonary (Pt_{0.8}Pd_{0.1}Au_{0.1})(Fe_{0.6}Co_{0.1}Ni_{0.1}Cu_{0.1}Sn_{0.1}) nanoparticles were also synthesized and featured (001), (110), and (111) planes with spacings of 3.73, 2.76, and 2.34 Å, respectively (e.g., as shown in the STEM images of FIGS. 2D-2F), also forming an L1₀ intermetallic structure. Thus, the disclosed process based on a disorder-to-order transition enables the synthesis of nanoscale MEIs with multiple elements (e.g., up to 8), as well as different elemental ratios and various intermetallic structures.

In contrast, it is very difficult to synthesize nanoscale MEIs without phase separation via conventional methods. As a control, Pt_{0.8}Pd_{0.1}Au_{0.1}Fe_{0.6}Co_{0.1}Ni_{0.1}Cu_{0.1}Sn_{0.1} nanoparticles were fabricated by conventional annealing (e.g., ˜1100 K, 3 h). These octonary nanoparticles were found to have formed phase-separated heterostructures without the desired atomic ordering according to STEM imaging and XRD. Phase separation occurs because the slowing heating/cooling rates of traditional annealing results in large particle size and distribution (˜76.2±4.2 nm) of the octonary Pt_{0.8}Pd_{0.1}Au_{0.1}Fe_{0.6}Co_{0.1}Ni_{0.1}Cu_{0.1}Sn_{0.1} nanoparticles, different from the MEI nanoparticles (˜5 nm) synthesized by the disclosed techniques. Thus, only by using the disclosed techniques can phase separation be avoided, which is made possible, at least in part, by starting the MEI nanoparticles with HEA nanoparticles that already have the constituent elements well-mixed. The limited heating duration of the technique also enables the disorder-to-order transition while preventing particle growth to successfully produce MEI nanoparticles.

To further investigate the disorder-to-order phase transition that enables MEI formation, an array of quinary Pt(Fe_{0.7}Co_{0.1}Ni_{0.1}Cu_{0.1}) samples were synthesized by heating at ˜1100 K for different amounts of time. XRD was then performed to characterize their degree of ordering. According to calculated virtual XRD patterns, the diffraction peaks of (001) at 24.2° and (110) at 33.4° are the superlattice peaks of the ideal L1₀ intermetallic structure of Pt(Fe_{0.7}Co_{0.1}Ni_{0.1}Cu_{0.1}). Based on the intensities of these peaks, the ordering degree of the different quinary samples can be quantified using the LRO parameter, as defined by equation (2) above. No superlattice diffraction peaks were observed for the sample made with only 0.05 s of Joule heating, suggesting that the short heating time is incapable of inducing the disorder-to-order phase transition for Pt₁Fe_{0.7}Co_{0.1}Ni_{0.1}Cu_{0.1}. As the heating time was increased from 0.5 s to 5 minutes, the characteristic diffraction peaks of L1₀, (001) and (110), gradually intensified. As a result, the LRO increased from 10% (0.5 s) to 60% (1 min) and finally ˜100% (5 min), as shown in FIG. 9A. As shown in FIG. 9B, the Rietveld refinement of the XRD results of the quinary Pt(Fe_{0.7}Co_{0.1}Ni_{0.1}Cu_{0.1}) MEI also reveals the formation of the fully ordered L1₀ intermetallic structure of the sample heated for 5 min, in which the Co, Ni, Cu, and Fe elements occupy one sub-lattice and Pt occupies the other sub-lattice.

This disorder-to-order transition process (0.5 s to 5 min) is also consistent with STEM imaging of the quinary Pt(Fe_{0.7}Co_{0.1}Ni_{0.1}Cu_{0.1}) MEI nanoparticles synthesized at ˜1100 K for different heating durations (as shown in FIGS. 9C-9E), which shows the disordered HEA nanoparticle structure converts to an MPEI structure over the course of −5 min heating. This disorder-to-order phase transition toward single-phase MPEIs consisting of immiscible elements can only be achieved at the nanoscale. For quinary Pt(Fe_{0.7}Co_{0.1}Ni_{0.1}Cu_{0.1}) nanoparticles, the fully ordered L1₀ structure (LRO=100%) can be obtained in particles of 4-5 nm. However, for larger particles, the LRO decreases with the particle size (as shown in FIG. 5D), irrespective of the particle synthesis method. When the particle size increases to ˜60 nm or larger, the particle shows disordered or other phase-separated heterostructures, as confirmed by STEM and EDX.

Monte Carlo (MC) simulations of different sized nanoparticles were conducted and the LRO change tracked as a function of the MC steps (corresponding to the reaction time) at 1100 K to further understand the transition at the nanoscale. The LROs of particles of 3.1 nm and 4.6 nm in size increase with the MC steps, then both reach ˜100% within 3×10⁷ steps, meaning both particles have completed the disorder-to-order phase transition at this point of the simulation progress. However, for a particle that is 7.7 nm in size, only a partial disorder-to-order transition (LRO=40%) can be achieved after 3×10′ simulation steps. The largest particle simulated was 10.8 nm, which shows an even lower LRO of 5% after the same number of MC simulation steps. These findings are consistent with the experimental observations using XRD (e.g., FIG. 5C) and STEM, in which the complete disorder-to-order phase transition is primarily achieved and stabilized in ultrasmall nanoparticles (<5 nm).

Without being bound by any particular theory, the size effect on the disorder-to-order transition can be attributed to the difference in surface energy. For example, MEIs can have a lower surface energy than HEAs, since MEIs form stronger atom-atom interactions. Due to the large relative surface area of small nanoparticles, the difference in the surface energy between MEI and HEA small nanoparticles (˜5 nm) can play a key role in driving the disorder-to-order transition. It is also possible that the larger particles (e.g., 10-20 nm) need to overcome a higher energy barrier to complete the disorder-to-order transition. For particles significantly larger than 5 nm (e.g., 150 nm), such a large energy barrier could hinder the formation of fully ordered MEIs. The disorder-to-order transition can be thermodynamically favored to form phase-stable MEI nanoparticles. The lower enthalpy of the MEI nanoparticles with a size of 4-5 nm was verified by conducting high-temperature oxide melt drop solution calorimetry on the quinary and octonary MEIs and their corresponding disordered HEA starting materials. According to the calorimetry measurements, the enthalpy change from the quinary HEA to MEI was −0.20 eV per Pt(Fe_{0.7}Co_{0.1}Ni_{0.1}Cu_{0.1}) formula, and for the octonary HEA to MEI the enthalpy change was −0.32 eV per (Pt_{0.8}Pd_{0.1}Au_{0.1})(Fe_{0.6}Co_{0.1}Ni_{0.1}Cu_{0.1}Sn_{0.1}) formula, indicating the ordered MEIs are thermodynamically favored.

The disorder-to-order phase transition was further simulated through MC modeling of the atomic arrangement of the quinary Pt(Fe_{0.7}Co_{0.1}Ni_{0.1}Cu_{0.1}) nanoparticle at 1100 K, which showed the atoms of the disordered HEA starting material diffusing to form the ordered MEI, similar to the transition process in other intermetallics. During the transition, the formation enthalpy (ΔH_{f}) of the quinary MEI decreases substantially, driven by the strong interaction via the spin-orbit coupling and the hybridization between non-noble metal 3d and noble 5d states. The decreased enthalpy leads to a lower Gibbs free energy of the MEI (Gₒ) than that of the HEA (G_{d}) sample (based on the same quinary composition PtFe_{0.7}Co_{0.1}Ni_{0.1}Cu_{0.1}) at a wide temperature range (˜273-1500 K), according to MC modeling. At temperatures below 1500 K (and above the decomposition temperature of the metal salts), the low enthalpy of the MEIs dominates the Gibbs free energy and thus Gₒ<G_{d}. Therefore, at the synthesis temperature (˜1100 K), the disorder-to-order transition is thermodynamically favored (ΔG_{d→o}=Gₒ−G_{d}<0) and at room temperature the ordered MEI is the thermodynamically stable phase.

Upon completing the disorder-to-order transition, the ultra-small MEI nanoparticles can display excellent phase stability, as evidenced by in situ heating a quinary Pt(Fe_{0.7}Co_{0.1}Ni_{0.1}Cu_{0.1}) MEI nanoparticle and simultaneously monitoring its phase evolution by STEM. The quinary MEI nanoparticle synthesized by Joule heating displayed a fully ordered structure even after 13 minutes of additional heating at ˜1100 K. The nanoparticle was maintained at ˜1100 K for another 47 minutes, but a phase change was still not observed, thereby indicating the thermal stability of the MEI nanoparticle. In contrast, the binary PtFe nanoparticles (˜5 nm) at ˜1100 K showed an ordered intermetallic structure (14 minutes) but gradually transformed to a disordered alloy (60 minutes), indicating the superior thermal stability of MEIs compared to binary intermetallics. Octonary MEI nanoparticles of (Pt_{0.8}Pd_{0.1}Au_{0.1})(Fe_{0.6}Co_{0.1}Ni_{0.1}Cu_{0.1}Sn_{0.1}) were fabricated on a Ketjenblack carbon support (Fig. S22) for use as an electrocatalyst for an ethanol oxidation reaction (EOR). EOR is the key reaction in direct alcohol fuel cells, such as fuel cell 900 in FIG. 9F. In particular, the fuel cell 900 includes an anode 902 with a gas diffusion layer 904 thereon, a cathode 910, and a proton exchange membrane (PEM) 908 disposed between the anode 902 and cathode 910. The PEM 908 can further include a catalyst layer 906, e.g., comprising a catalytic structure of octonary MEI nanoparticles. Ethanol, via inlet flow 912 on an anode side of PEM 908, is oxidized at the anode 902 to form an outlet flow 914 of CO₂. At a same time, oxygen, via inlet flow 916 on a cathode side of PEM 908, is reduced at the cathode 910 to form an outlet flow 918 of H₂O. Protons are transported through the PEM 908, while electrons are transported through an external circuit (not shown) from the anode 902 to the cathode 910, thereby providing power to a load.

However, EOR requires efficient catalysts with high-surface area, tunable composition, and good stability, which features can be enabled by use of octonary MEI nanoparticles ((Pt_{0.8}Pd_{0.1}Au_{0.1})(Fe_{0.6}Co_{0.1}Ni_{0.1}Cu_{0.1}Sn_{0.1})) as anode catalyst 906. FIG. 9G shows the resulting EOR constant voltage (CV) curves for the (Pt_{0.8}Pd_{0.1}Au_{0.1})(Fe_{0.6}Co_{0.1}Ni_{0.1}Cu_{0.1}Sn_{0.1}) MEI nanoparticles, binary PtFe intermetallic nanoparticles, and commercial Pt/C catalyst tested in 1 M KOH and 1 M EtOH. As shown by FIG. 9G, the MEI nanoparticles demonstrate improved EOR activity that is 8- and 12-times higher than the binary PtFe intermetallic and commercial Pt/C catalyst, respectively. Moreover, the octonary MEI nanoparticles demonstrate excellent durability during long-term catalytic operation, which may be attributed to the material's multi-elemental composition, ordered intermetallic structure, and nanosize.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A structure comprising:
one or more multi-element compound (MEC) nanoparticles, each MEC nanoparticle having a plurality of sites comprising one or more elements, each site forming a compound bond with at least one other site of the compound nanoparticle,
wherein one or more of the compound bonds comprises a covalent bond, an ionic bond, a metallic bond, or any combination of the foregoing, and
each MEC nanoparticle is formed of at least three different elements.
   Clause 2. The structure of any clause or example herein, in particular, Clause 1, wherein each MEC nanoparticle has a maximum cross-sectional dimension less than or equal to 25 nm.
   Clause 3. The structure of any clause or example herein, in particular, any one of Clauses 1-2, wherein the one or more MEC nanoparticles comprises a multi-element oxide nanoparticle, a multi-element carbide nanoparticle, a multi-element intermetallic nanoparticle, a multi-element nitride nanoparticle, a multi-element amorphous glass nanoparticle, a multi-element diboride nanoparticle, a multi-element phosphide nanoparticle, a multi-element sulfide nanoparticle, a multi-element chalcogenide nanoparticle, a multi-element silicide nanoparticle, or any combination of the foregoing.
   Clause 4. The structure of any clause or example herein, in particular, any one of Clauses 1-3, further comprising:
a substrate,
wherein the one or more MEC nanoparticles are formed on one or more surfaces of the substrate, the one or more MEC nanoparticles are coupled to one or more surfaces of the substrate, or both.
   Clause 5. The structure of any clause or example herein, in particular, Clause 4, wherein the substrate comprises a carbon nanofiber (CNF), carbon nanotube (CNT), mesoporous carbon molecular sieve (CMK), carbon paper, carbon felt, carbon black powder or particle, graphite powder or particle, graphene, carbonized wood, a semiconductor, a textile, a metal, a dielectric, an oxide, or any combination of the foregoing.
   Clause 6. The structure of any clause or example herein, in particular, any one of Clauses 1-5, wherein at least one of the one or more MEC nanoparticles comprises a multi-element oxide (EG) nanoparticle, and the MEO nanoparticle comprises oxygen and at least three cations in a single homogenous phase.
   Clause 7. The structure of any clause or example herein, in particular, Clause 6, wherein the E nanoparticle comprises more than five cations in the single homogenous phase.
   Clause 8. The structure of any clause or example herein, in particular, any one of Clauses 6-7, wherein the MEO nanoparticle has a crystal structure selected from the group consisting of rock-salt, spinel, rutile, fluorite, tungsten bronze, and perovskite.
   Clause 9. The structure of any clause or example herein, in particular, any one of Clauses 6-8, wherein the at least three cations forming the MEO nanoparticle are selected from the group consisting of Ba, Ca, Ce, Co, Cr, Cu, Dy, Er, Eu, Fe, Gd, Hf, Ir, K, La, Li, Mg, Mn, Mo, Na, Nb, Nd, Ni, Pb, Pd, Pr, Sm, Sn, Sr, Ta, Ti, V, Y, Zn, and Zr.
   Clause 10. The structure of any clause or example herein, in particular, any one of Clauses 6-9, wherein the at least three cations comprises at least one transition metal and at least one noble metal.
   Clause 11. The structure of any clause or example herein, in particular, any one of Clauses 6-10, wherein the MEO nanoparticle comprises Pd.
   Clause 12. The structure of any clause or example herein, in particular, any one of Clauses 6-11, wherein the MEO nanoparticle is a denary oxide having a formula of (Zr,Ce)_{0.6}(Mg,La,Y,Hf,Ti,Cr,Mn)_{0.3}Pd_{0.1}O₂₋ₓ, where x represents oxygen vacancy.
   Clause 13. The structure of any clause or example herein, in particular, any one of Clauses 6-11, wherein the MEO nanoparticle is a denary oxide having a formula of (Zr,Ce,Hf,Ti,La,Y,Gd,Ca,Mg,Mn)O₂₋ₓ, where x represents oxygen vacancy.
   Clause 14. The structure of any clause or example herein, in particular, any one of Clauses 6-13, wherein the MEO nanoparticle has a configurational entropy greater than or equal to 13.5 J/mol/K.
   Clause 15. The structure of any clause or example herein, in particular, any one of Clauses 6-14, further comprising a coating formed on and enclosing at least part of the MEO nanoparticle.
   Clause 16. The structure of any clause or example herein, in particular, Clause 15, wherein the coating comprises a polymer comprising C, G, and H.
   Clause 17. The structure of any clause or example herein, in particular, any one of Clauses 15-16, wherein the coating comprises polyvinyl alcohol (PVA), polyvinylpyrrolidone (PVP), polyvinylidene difluoride (PVDF), polytetrafluoroethylene (PTFE), or any combination of the foregoing.
   Clause 18. The structure of any clause or example herein, in particular, any one of Clauses 1-17, wherein at least one of the one or more MEC nanoparticles comprises a multi-element intermetallic (MEI) nanoparticle, and the MEI nanoparticle comprises at least three metal elements in a single phase.
   Clause 19. The structure of any clause or example herein, in particular, Clause 18, wherein the MEI nanoparticle has a maximum cross-sectional dimension of about 4-6 nm.
   Clause 20. The structure of any clause or example herein, in particular, any one of Clauses 18-19, wherein the MEI nanoparticle has a first and second sub-lattices, one of the at least three metal elements is distributed in the first sub-lattice, and another of the at least three metal elements is distributed in the second sub-lattice.
   Clause 21. The structure of any clause or example herein, in particular, Clause 20, wherein the first sub-lattice has a random distribution of noble metal atoms, and the second sub-lattice has a random distribution of non-noble metal atoms.
   Clause 22. The structure of any clause or example herein, in particular, any one of Clauses 18-21, wherein the MEI nanoparticle has a geometrically closed-packed phase or a topologically closed-packed phase.
   Clause 23. The structure of any clause or example herein, in particular, Clause 22, wherein the geometrically closed-packed phase comprises a lattice structure of L1₀, L1₁, L1₂, or B₂, and the topologically closed-packed phase comprises a Laves phase, a σ phase, or a μ phase.
   Clause 24. The structure of any clause or example herein, in particular, any one of Clauses 18-23, wherein the MEI nanoparticle comprises more than five metal elements.
   Clause 25. The structure of any clause or example herein, in particular, any one of Clauses 18-24, wherein the MEI nanoparticle is an octonary nanoparticle having a formula of (Pt_{0.8}Pd_{0.1}Au_{0.1})(Fe_{0.6}Co_{0.1}Ni_{0.1}Cu_{0.1}Sn_{0.1}).
   Clause 26. The structure of any clause or example herein, in particular, any one of Clauses 18-25, wherein the MEI nanoparticle exhibits a long-range ordering (LRO) of at least 90%. Clause 27. The structure of any clause or example herein, in particular, any one of Clauses 18-26, wherein the MEI nanoparticle exhibits an LRO of about 100%.
   Clause 28. The structure of any clause or example herein, in particular, any one of Clauses 1-27, wherein at least one of the one or more MEC nanoparticles comprises a multi-element carbide nanoparticle, and the multi-element carbide nanoparticle comprises carbon and at least three metal elements in a single homogenous phase.
   Clause 29. The structure of any clause or example herein, in particular, Clause 28, wherein the multi-element carbide nanoparticle comprises more than five metal elements in the single homogenous phase.
   Clause 30. The structure of any clause or example herein, in particular, any one of Clauses 28-29, wherein the at least three metal elements forming the multi-element carbide nanoparticle are selected from the group consisting of Ba, Ca, Ce, Co, Cr, Cu, Dy, Er, Eu, Fe, Gd, Hf, Ir, K, La, Li, Mg, Mn, Mo, Na, Nb, Nd, Ni, Pb, Pd, Pr, Sm, Sn, Sr, Ta, Ti, V, Y, Zn, and Zr.
   Clause 31. The structure of any clause or example herein, in particular, any one of Clauses 28-30, wherein the multi-element carbide nanoparticle is a quinary carbide having a formula of (TiZrVNbMo)Cₓ.
   Clause 32. The structure of any clause or example herein, in particular, any one of Clauses 1-31, wherein the structure is constructed for use as a catalyst in a thermochemical reaction or electrochemical reaction.
   Clause 33. A method comprising:
(a) providing a substrate with a plurality of metal salt precursors thereon, at least one of the metal salt precursors comprising O, the plurality of metal salt precursors comprising at least three different metal elements;
(b) heating the substrate from an initial temperature to a first temperature at a first heating rate of at least 10⁴ K/s;
(c) maintaining the substrate at the first temperature for a first time period; and
(d) at an end of the first time period, cooling the substrate from the first temperature to a second temperature at a first cooling rate of at least 10⁵ K/s,
wherein the initial temperature and the second temperature are less than 500 K, and
the heating of (b), the maintaining of (c), and the cooling of (d) are such that the metal salt precursors on the substrate are converted to one or more multi-element oxide (MEO) nanoparticles, each MEO nanoparticle comprising oxygen and the at least three metal elements in a single homogenous phase.
   Clause 34. The method of any clause or example herein, in particular, Clause 33, wherein the initial temperature, the second temperature, or both are about 290-300 K.
   Clause 35. The method of any clause or example herein, in particular, any one of Clauses 33-34, wherein the first temperature is in a range of 1400 K to 1600 K, inclusive, and the first time period is about 50-55 ms.
   Clause 36. The method of any clause or example herein, in particular, any one of Clauses 33-34, wherein the first temperature is in a range of 1200 K to 1400 K, inclusive, and the first time period is about 200 ms.
   Clause 37. The method of any clause or example herein, in particular, any one of Clauses 33-36, wherein the heating of (b), the maintaining of (c), and the cooling of (d) are performed in an atmosphere of noble gas and/or the atmosphere has less than or equal to 1 ppm of oxygen.
   Clause 38. The method of any clause or example herein, in particular, Clause 37, wherein the noble gas comprises Ar.
   Clause 39. The method of any clause or example herein, in particular, any one of Clauses 33-38, wherein the plurality of metal salt precursors comprises Ni, Cu, or Fe, and the heating of (b), the maintaining of (c), and the cooling of (d) are performed in an atmosphere having an oxygen partial pressure.
   Clause 40. The method of any clause or example herein, in particular, Clause 39, wherein the atmosphere comprises ambient air and/or the atmosphere contains at least 15% vol. of O (e.g., ˜20.95% vol) and/or the atmosphere has an oxygen partial pressure of at least 150 mbar (e.g., ˜212.3 mbar).
   Clause 41. The method of any clause or example herein, in particular, any one of Clauses 33-40, wherein the at least three metal elements are selected from the group consisting of Ba, Ca, Ce, Co, Cr, Cu, Dy, Er, Eu, Fe, Gd, Hf, Ir, K, La, Li, Mg, Mn, Mo, Na, Nb, Nd, Ni, Pb, Pd, Pr, Sm, Sn, Sr, Ta, Ti, V, Y, Zn, and Zr.
   Clause 42. The method of any clause or example herein, in particular, any one of Clauses 33-41, wherein the plurality of metal salt precursors comprises ten different metal elements, at least one of which is a noble metal.
   Clause 43. The method of any clause or example herein, in particular, Clause 42, wherein the noble metal is Pd.
   Clause 44. The method of any clause or example herein, in particular, any one of Clauses 33-43, wherein the MEO nanoparticle is a denary oxide having a formula of (Zr,Ce)_{0.6}(Mg,La,Y,Hf,Ti,Cr,Mn)_{0.3}Pd_{0.1}O₂₋ₓ, where x represents oxygen vacancy.
   Clause 45. The method of any clause or example herein, in particular, any one of Clauses 33-43, wherein the MEO nanoparticle is a denary oxide having a formula of (Zr,Ce,Hf,Ti,La,Y,Gd,Ca,Mg,Mn)O₂₋ₓ, where x represents oxygen vacancy.
   Clause 46. The method of any clause or example herein, in particular, any one of Clauses 33-45, wherein the substrate comprises a carbon nanofiber (CNF), carbon nanotube (CNT), mesoporous carbon molecular sieve (CMK), carbon paper, carbon felt, carbon black powder or particle, graphite powder or particle, graphene, carbonized wood, a semiconductor, a textile, a metal, a dielectric, an oxide, or any combination of the foregoing.
   Clause 47. The method of any clause or example herein, in particular, any one of Clauses 33-46, wherein the heating comprises direct Joule heating, conduction heating, radiative heating, microwave heating, laser heating, plasma heating, or any combination of the foregoing.
   Clause 48. The method of any clause or example herein, in particular, any one of Clauses 33-47, wherein the cooling comprises (i) passive cooling by radiation, conduction, or both, (ii) active cooling by conduction, convection, or both, (iii) active cooling by phase or chemical transitions induced by heat absorption, or (iv) any combination of (i), (ii), and (iii).
   Clause 49. The method of any clause or example herein, in particular, any one of Clauses 33-48, further comprising, after the cooling of (d):
(e) providing a coating on and at least partially enclosing the one or more MEO nanoparticles;
(f) heating the substrate from a third temperature to a fourth temperature at a second heating rate slower than the first heating rate;
(g) maintaining the substrate at the fourth temperature for a second time period; and
(h) at an end of the second time period, cooling the substrate from the fourth temperature to a fifth temperature at a second cooling rate of at least 10⁵ K/s,
wherein the third temperature and the fifth temperature are less than 500K, and
the heating of (f), the maintaining of (g), and the cooling of (h) are such that the one or more MEO nanoparticles and the coating are converted to one or more multi-element carbide nanoparticles, each multi-element carbide nanoparticle comprising carbon and the at least three metal elements in a single homogenous phase.
   Clause 50. The method of any clause or example herein, in particular, any one of Clauses 33-48, further comprising, after the cooling of (d):
(e) providing a coating on and at least partially enclosing the one or more MEO nanoparticles;
(f) heating the substrate from a third temperature to a fourth temperature at a third heating rate of at least 10⁴ K/s;
(g) maintaining the substrate at the fourth temperature for a time interval;
(h) at an end of the time interval, cooling the substrate from the fourth temperature to a fifth temperature at a second cooling rate of at least 10⁵ K/s; and
(i) repeating the heating of (f), the maintaining of (g), and the cooling of (h) one or more times to define a second time period,
wherein the third temperature and the fifth temperature are less than 500K, and
the heating of (f), the maintaining of (g), the cooling of (h), and the repeating of (i) are such that the one or more MEO nanoparticles and the coating are converted to one or more multi-element carbide nanoparticles, each multi-element carbide nanoparticle comprising carbon and the at least three metal elements in a single homogenous phase.
   Clause 51. The method of any clause or example herein, in particular, any one of Clauses 49-50, wherein the third temperature, the fifth temperature, or both are about 290-300 K.
   Clause 52. The method of any clause or example herein, in particular, any one of Clauses 49-51, wherein the fourth temperature is at least 200 K greater than the first temperature, and the second time period is at least 100 times greater than the first time period.
   Clause 53. The method of any clause or example herein, in particular, any one of Clauses 49-52, wherein the fourth temperature is about 2000 K, and the second time period is about 60 seconds.
   Clause 54. The method of any clause or example herein, in particular, any one of Clauses 49-53, wherein the coating comprises a polymer comprising C, O, and H.
   Clause 55. The method of any clause or example herein, in particular, any one of Clauses 49-54, wherein the coating comprises polyvinyl alcohol (PVA), polyvinylpyrrolidone (PVP), polyvinylidene difluoride (PVDF), polytetrafluoroethylene (PTFE), or any combination of the foregoing.
   Clause 56. A method comprising:
(a) providing a substrate with one or more high entropy alloy (HEA) nanoparticles thereon, each HEA nanoparticle comprising at least five different metal elements;
(b) heating the substrate to a first temperature at a first heating rate of at least 10⁴ K/s;
(c) maintaining the substrate at the first temperature for a first time period; and
(d) at an end of the first time period, cooling the substrate from the first temperature to a second temperature at a first cooling rate of at least 10⁵ K/s,
wherein the second temperature is less than 500 K,
the first temperature is greater than 1000 K, and the first time period is in a range of 1 minute to 10 minutes, inclusive, and
the heating of (b), the maintaining of (c), and the cooling of (d) are such that the one or more HEA nanoparticles are converted to one or more multi-element intermetallic (MEI) nanoparticles, each MEI nanoparticle comprising the at least five metal elements in a single phase.
   Clause 57. The method of any clause or example herein, in particular, Clause 56, wherein:
the providing of (a) comprises:
   (a1) providing the substrate with a plurality of metal salt precursors thereon, the plurality of metal salt precursors comprising the at least five different metal elements;
   (a2) heating the substrate from an initial temperature to a third temperature at a second heating rate of at least 10⁴ K/s;
   (a3) maintaining the substrate at the third temperature for a second time period; and
   (a4) at an end of the second time period, cooling the substrate from the third temperature to a fourth temperature at a second cooling rate of at least 10⁵ K/s;
the initial temperature and the fourth temperature are less than 500K,
the third temperature is greater than 1000 K, and the second time period is in a range of 10 ms to 100 ms, inclusive, and
the heating of (a2), the maintaining of (a3), and the cooling of (a4) are such that the metal salt precursors on the substrate are converted to the one or more HEA nanoparticles.
   Clause 58. The method of any clause or example herein, in particular, Clause 57, wherein one, some, or all of the initial temperature, the second temperature, and the fourth temperature are about 290-300 K.
   Clause 59. The method of any clause or example herein, in particular, any one of Clauses 57-58, wherein the third temperature is about 1100 K, and the second time period is about 50-55 ms.
   Clause 60. A method comprising:
(a) providing a substrate with one or more disordered nanoparticles thereon, the one or more disordered nanoparticles comprising at least three different metal elements and having a long-range order (LRO) less than 50%;
(b) heating the substrate to a first temperature at a first heating rate of at least 10⁴ K/s;
(c) maintaining the substrate at the first temperature for a first time period; and
(d) at an end of the first time period, cooling the substrate from the first temperature to a second temperature at a first cooling rate of at least 10⁵ K/s,
wherein the second temperature is less than 500 K,
the first temperature is greater than 1000 K, and the first time period is in a range of 1 minute to 10 minutes, inclusive, and
the heating of (b), the maintaining of (c), and the cooling of (d) are such that the one or more disordered nanoparticles are converted to one or more multi-element intermetallic (MEI) nanoparticles, each MEI nanoparticle comprising the at least three metal elements in a single phase.
   Clause 61. The method of any clause or example herein, in particular, Clause 60, wherein:
the providing of (a) comprises:
   (a1) providing the substrate with a plurality of metal salt precursors thereon, the plurality of metal salt precursors comprising the at least three different metal elements;
   (a2) heating the substrate from an initial temperature to a third temperature at a second heating rate of at least 10⁴ K/s;
   (a3) maintaining the substrate at the third temperature for a second time period; and
   (a4) at an end of the second time period, cooling the substrate from the third temperature to a fourth temperature at a second cooling rate of at least 10⁵ K/s;
the initial temperature and the fourth temperature are less than 500K,
the third temperature is greater than 1000 K, and the second time period is in a range of 10 ms to 100 ms, inclusive, and
the heating of (a2), the maintaining of (a3), and the cooling of (a4) are such that the metal salt precursors on the substrate are converted to the one or more disordered nanoparticles.
   Clause 62. The method of any clause or example herein, in particular, Clause 61, wherein one, some, or all of the initial temperature, the second temperature, and the fourth temperature are about 290-300 K.
   Clause 63. The method of any clause or example herein, in particular, any one of Clauses 61-62, wherein the third temperature is about 1100 K, and the second time period is about 50-55 ms.
   Clause 64. The method of any clause or example herein, in particular, any one of Clauses 56-63, wherein the first temperature is about 1100 K, and the first time period is about 5 minutes.
   Clause 65. The method of any clause or example herein, in particular, any one of Clauses 56-64, wherein each MEI nanoparticle has a geometrically closed-packed phase or a topologically closed-packed phase.
   Clause 66. The method of any clause or example herein, in particular, Clause 65, wherein the geometrically closed-packed phase comprises a lattice structure of L1₀, L1₁, L1₂, or B₂, and the topologically closed-packed phase comprises a Laves phase, a σ phase, or a μ phase.
   Clause 67. The method of any clause or example herein, in particular, any one of Clauses 56-66, wherein the one or more MEI nanoparticles comprises more than six metal elements, more than seven metal elements, or more than eight metal elements.
   Clause 68. The method of any clause or example herein, in particular, any one of Clauses 56-67, wherein each MEI nanoparticle is an octonary nanoparticle having a formula of (Pt_{0.8}Pd_{0.1}Au_{0.1})(Fe_{0.6}Co_{0.1}Ni_{0.1}Cu_{0.1}Sn_{0.1}).
   Clause 69. The method of any clause or example herein, in particular, any one of Clauses 56-68, wherein each MEI nanoparticle exhibits a long-range ordering (LRO) of at least 90%.
   Clause 70. The method of any clause or example herein, in particular, any one of Clauses 56-69, wherein each MEI nanoparticle exhibits an LRO of about 100%.
   Clause 71. A system for fabrication of a multi-element compound nanoparticle of any clause or example herein, in particular, any one of Clauses 1-32, the system comprising a pulsed or semi-continuous heating mechanism.
   Clause 72. The system of any clause or example herein, in particular, Clause 71, wherein the pulsed or semi-continuous heating mechanism comprises one or more of a direct Joule heater, a conduction heater, a radiative heater, a microwave heater, a laser, a plasma, or any combination of the foregoing, or any other means for heating.
   Clause 73. The system of any clause or example herein, in particular, any one of Clauses 71-72, further comprising a rapid cooling mechanism.
   Clause 74. The system of any clause or example herein, in particular, Clause 73, wherein the rapid cooling mechanism comprises (i) passive cooling by radiation, conduction, or both, (ii) active cooling by conduction, convection, or both, (iii) active cooling by phase or chemical transitions induced by heat absorption, (iv) any other means for rapid cooling, or (v) any combination of (i), (ii), (iii), and (iv).
   Clause 75. The system of any clause or example herein, in particular, any one of Clauses 71-74, further comprising a controller operatively coupled to and configured to control the pulsed heating mechanism and/or the rapid cooling mechanism.
   Clause 76. The system of any clause or example herein, in particular, Clause 75, wherein the controller comprises one or more processors and computer readable storage media.
   Clause 77. The system of any clause or example herein, in particular, Clause 76, wherein the computer readable storage media stores instructions that, when executed by the one or more processors, cause the controller to perform and/or to issue control signals to cause performance of one or more aspects of the method of any clause or example herein, in particular, any one of Clauses 33-70.

### CONCLUSION

Any of the features illustrated or described herein, for example, with respect to FIGS. 1B-1E, 2B-2G, 3-7D, and 8A-9G and Clauses 1-77, can be combined with any other feature illustrated or described herein, for example, with respect to FIGS. 1B-1E, 2B-2G, 3-7D, and 8A-9G and Clauses 1-77 to provide materials, structures, methods, and embodiments not otherwise illustrated or specifically described herein. All features described herein are independent of one another and, except where structurally impossible, can be used in combination with any other feature described herein.

In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A structure comprising:
one or more multi-element compound (MEC) nanoparticles, each MEC nanoparticle having a plurality of sites comprising one or more elements, each site forming a compound bond with at least one other site of the compound nanoparticle,
wherein one or more of the compound bonds comprises a covalent bond, an ionic bond, a metallic bond, or any combination of the foregoing, and
each MEC nanoparticle is formed of at least three different elements.

2-5. (canceled)

6. The structure of claim 1, wherein at least one of the one or more MEC nanoparticles comprises a multi-element oxide (MEO) nanoparticle, and the MEO nanoparticle comprises oxygen and at least three cations in a single homogenous phase.

7-8. (canceled)

9. The structure of claim 6, wherein the at least three cations forming the MEO nanoparticle are selected from the group consisting of Ba, Ca, Ce, Co, Cr, Cu, Dy, Er, Eu, Fe, Gd, Hf, Ir, K, La, Li, Mg, Mn, Mo, Na, Nb, Nd, Ni, Pb, Pd, Pr, Sm, Sn, Sr, Ta, Ti, V, Y, Zn, and Zr.

10-11. (canceled)

12. The structure of claim 6, wherein the MEO nanoparticle is a denary oxide having a formula of (Zr,Ce)_{0.6}(Mg,La,Y,Hf,Ti,Cr,Mn)_{0.3}Pd_{0.1}O₂₋ₓ, where x represents oxygen vacancy.

13. The structure of claim 6, wherein the MEO nanoparticle is a denary oxide having a formula of (Zr,Ce,Hf,Ti,La,Y,Gd,Ca,Mg,Mn)O₂₋ₓ, where x represents oxygen vacancy.

14-17. (canceled)

18. The structure of claim 1, wherein at least one of the one or more MEC nanoparticles comprises a multi-element intermetallic (MEI) nanoparticle, and the MEI nanoparticle comprises at least three metal elements in a single phase.

19-20. (canceled)

21. The structure of claim 18, wherein:
the MEI nanoparticle has a first and second sub-lattices, one of the at least three metal elements is distributed in the first sub-lattice, and another of the at least three metal elements is distributed in the second sub-lattice, and
the first sub-lattice has a random distribution of noble metal atoms, and the second sub-lattice has a random distribution of non-noble metal atoms.

22. The structure of claim 18, wherein:
the MEI nanoparticle has a geometrically closed-packed phase or a topologically closed-packed phase, and
the geometrically closed-packed phase comprises a lattice structure of L₀, L1₁, L1₂, or B₂, and the topologically closed-packed phase comprises a Laves phase, a σ phase, or a μ phase.

23-25. (canceled)

26. The structure of claim 18, wherein the MEI nanoparticle exhibits a long-range ordering (LRO) of at least 90%.

27. (canceled)

28. The structure of claim 1, wherein at least one of the one or more MEC nanoparticles comprises a multi-element carbide nanoparticle, and the multi-element carbide nanoparticle comprises carbon and at least three metal elements in a single homogenous phase.

29-32. (canceled)

33. A method comprising:
(a) providing a substrate with a plurality of metal salt precursors thereon, at least one of the metal salt precursors comprising O, the plurality of metal salt precursors comprising at least three different metal elements;
(b) heating the substrate from an initial temperature to a first temperature at a first heating rate of at least 10⁴ K/s;
(c) maintaining the substrate at the first temperature for a first time period; and
(d) at an end of the first time period, cooling the substrate from the first temperature to a second temperature at a first cooling rate of at least 10⁵ K/s,
wherein the initial temperature and the second temperature are less than 500 K, and
the heating of (b), the maintaining of (c), and the cooling of (d) are such that the metal salt precursors on the substrate are converted to one or more multi-element oxide (MEO) nanoparticles, each MEO nanoparticle comprising O and the at least three metal elements in a single homogenous phase.

34-36. (canceled)

37. The method of claim 33, wherein the heating of (b), the maintaining of (c), and the cooling of (d) are performed in an atmosphere of noble gas.

38. (canceled)

39. The method of claim 33, wherein the plurality of metal salt precursors comprises Ni, Cu, or Fe, and the heating of (b), the maintaining of (c), and the cooling of (d) are performed in an atmosphere having an oxygen partial pressure.

40-43. (canceled)

44. The method of claim 33, wherein the MEO nanoparticle is a denary oxide having a formula of (Zr,Ce)_{0.6}(Mg,La,Y,Hf,Ti,Cr,Mn)_{0.3}Pd_{0.1}O₂₋ₓ, where x represents oxygen vacancy.

45. The method of claim 33, wherein the MEO nanoparticle is a denary oxide having a formula of (Zr,Ce,Hf,Ti,La,Y,Gd,Ca,Mg,Mn)O₂₋ₓ, where x represents oxygen vacancy.

46-48. (canceled)

49. The method of claim 33, further comprising, after the cooling of (d):
(e) providing a coating on and at least partially enclosing the one or more MEO nanoparticles;
(f) heating the substrate from a third temperature to a fourth temperature at a second heating rate slower than the first heating rate;
(g) maintaining the substrate at the fourth temperature for a second time period; and
(h) at an end of the second time period, cooling the substrate from the fourth temperature to a fifth temperature at a second cooling rate of at least 10⁵ K/s,
wherein the third temperature and the fifth temperature are less than 500K, and
the heating of (f), the maintaining of (g), and the cooling of (h) are such that the one or more MEO nanoparticles and the coating are converted to one or more multi-element carbide nanoparticles, each multi-element carbide nanoparticle comprising carbon and the at least three metal elements in a single homogenous phase.

50. The method of claim 33, further comprising, after the cooling of (d):
(e) providing a coating on and at least partially enclosing the one or more MEO nanoparticles;
(f) heating the substrate from a third temperature to a fourth temperature at a third heating rate of at least 10⁴ K/s;
(g) maintaining the substrate at the fourth temperature for a time interval;
(h) at an end of the time interval, cooling the substrate from the fourth temperature to a fifth temperature at a second cooling rate of at least 10⁵ K/s; and
(i) repeating the heating of (f), the maintaining of (g), and the cooling of (h) one or more times to define a second time period,
wherein the third temperature and the fifth temperature are less than 500K, and
the heating of (f), the maintaining of (g), the cooling of (h), and the repeating of (i) are such that the one or more MEO nanoparticles and the coating are converted to one or more multi-element carbide nanoparticles, each multi-element carbide nanoparticle comprising carbon and the at least three metal elements in a single homogenous phase.

51-55. (canceled)

56. A method comprising:
(a) providing a substrate with one or more high entropy alloy (HEA) nanoparticles thereon, each HEA nanoparticle comprising at least five different metal elements;
(b) heating the substrate to a first temperature at a first heating rate of at least 10⁴ K/s;
(c) maintaining the substrate at the first temperature for a first time period; and
(d) at an end of the first time period, cooling the substrate from the first temperature to a second temperature at a first cooling rate of at least 10⁵ K/s,
wherein the second temperature is less than 500 K,
the first temperature is greater than 1000 K, and the first time period is in a range of 1 minute to 10 minutes, inclusive, and
the heating of (b), the maintaining of (c), and the cooling of (d) are such that the one or more HEA nanoparticles are converted to one or more multi-element intermetallic (MEI) nanoparticles, each MEI nanoparticle comprising the at least five metal elements in a single phase.

57. The method of claim 56, wherein:
the providing of (a) comprises:
(a1) providing the substrate with a plurality of metal salt precursors thereon, the plurality of metal salt precursors comprising the at least five different metal elements;
(a2) heating the substrate from an initial temperature to a third temperature at a second heating rate of at least 10⁴ K/s;
(a3) maintaining the substrate at the third temperature for a second time period; and
(a4) at an end of the second time period, cooling the substrate from the third temperature to a fourth temperature at a second cooling rate of at least 10⁵ K/s;
the initial temperature and the fourth temperature are less than 500K,
the third temperature is greater than 1000 K, and the second time period is in a range of 10 ms to 100 ms, inclusive, and
the heating of (a2), the maintaining of (a3), and the cooling of (a4) are such that the metal salt precursors on the substrate are converted to the one or more HEA nanoparticles.

58-64. (canceled)

65. The method of claim 56, wherein each MEI nanoparticle exhibits a long-range ordering (LRO) of at least 90%.

66. (canceled)
